(19) United States
(12) Patent Application Publication
(10) Pub. No.: US 2024/0390721 A1
(43) Pub. Date: Nov. 28, 2024

(54) LOW-TEMPERATURE MINERALIZATION OF A PERFLUOROALKYL AND POLYFLUOROALKYL SUBSTANCE IN POLAR APROTIC SOLVENTS

(71) Applicant: Northwestern University, Evanston, IL (US)

(72) Inventors: William R. Dichtel, Evanston, IL (US); Brittany Trang, Evanston, IL (US)

(21) Appl. No.: 18/696,742

(22) PCT Filed: Sep. 28, 2022
(86) PCT No.: PCT/US22/77209

§ 371 Date: Mar. 28, 2024

Related U.S. Application Data
(60) Provisional application No. 63/261,772, filed on Sep. 28, 2021.

(51) Int. Cl. A62D 3/34; A62D 3/36; A62D 3/40; A62D 101/22

(52) U.S. Cl. CPC A62D 3/34; A62D 3/36; A62D 3/40; A62D 2101/22

(57) ABSTRACT

Disclosed herein are methods for mineralizing a perfluoroalkyl and polyfluoroalkyl substance (PFAS), the method comprising heating a solution comprising the PFAS, a base, and a polar aprotic solvent to an effective mineralization temperature.

### CROSS-REFERENCE TO RELATED APPLICATIONS

The present application claims priority to U.S. Provisional Patent Application No. 63/261,772, filed Sep. 28, 2021, the entire contents of which are hereby incorporated by reference.

### STATEMENT REGARDING FEDERALLY SPONSORED RESEARCH

This invention was made with government support under DGE-1842165 awarded by National Science Foundation. The government has certain rights in the invention.

### BACKGROUND OF THE INVENTION

Perfluoroalkyl and polyfluoroalkyl substances (PFAS) are anthropogenic substances containing multiple carbon-fluorine bonds. PFAS are used as omniphobic surfactants in many industrial processes and products, including poly(tetrafluoroethylene) production, as water-, oil-, and stain-resistant barriers for fabrics and food service containers, and as components of aqueous film-forming foams for fire suppression. As a result of their widespread global use, environmental persistence, and bioaccumulation, PFAS contamination is pervasive, having been detected in the blood of 98% of a representative sample of the United States population, and affects drinking water, surface waters, livestock, and agricultural products around the world. This persistent environmental contamination is alarming because chronic exposure to even low levels of these compounds is associated with negative health effects such as thyroid disease, liver damage, high cholesterol, reduced immune responses, low birth weights, and several cancers. In recent years, the growing focus on removing parts-per billion (ppb) to parts-per-trillion (ppt) levels of PFAS contamination from drinking water supplies has produced several PFAS removal approaches, including established adsorbents such as activated carbons and ion-exchange resins as well as emerging materials such as cross-linked polymers. Adsorbents or membrane-based separation processes create PFAS-contaminated solid or liquid waste streams but do not address how to degrade these persistent pollutants. PFAS destruction is a daunting task because the strong C—F bonds that give PFAS desirable properties such as lipo- and hydrophobicity and high thermal stability also make these compounds resist end-of-life degradation. To address this problem, PFAS degradation methods have been investigated with varying levels of success, such as incineration, ultrasonication, plasma-based oxidation, electrochemical degradation, supercritical water oxidation, ultraviolet-initiated degradation using additives such as sulfite or iron, and other combinations of chemical and energy inputs. To effectively mineralize PFAS and eliminate human exposure to these toxic compounds, new methods that enable PFAS destruction must be developed.

### BRIEF SUMMARY OF THE INVENTION

Disclosed herein are methods for mineralizing a perfluoroalkyl and polyfluoroalkyl substance (PFAS), the method comprising heating a solution comprising the PFAS, a base, and a polar aprotic solvent to an effective mineralization temperature. The disclosed technology allows removal of an anionic moiety, such as through decarboxylation, and low-barrier defluorination mechanisms to mineralize PFAS at mild temperatures with high defluorination and low organofluorine side product formation. The conditions described here can destroy concentrated solutions of PFAS, give high fluoride ion recovery and low byproduct formation, and operate under relatively mild conditions with inexpensive reagents.

### BRIEF DESCRIPTION OF THE DRAWINGS

Non-limiting embodiments of the present invention will be described by way of example with reference to the accompanying figures, which are schematic and are not intended to be drawn to scale. In the figures, each identical or nearly identical component illustrated is typically represented by a single numeral. For purposes of clarity, not every component is labeled in every figure, nor is every component of each embodiment of the invention shown where illustration is not necessary to allow those of ordinary skill in the art to understand the invention.

FIG. 1. Overview of degradation pathways identified in this study. Heating PFCAs in polar aprotic solvents such as DMSO decarboxylates them to 1H-perfluoroalkanes. When this reaction is performed in the presence of NaOH, the PFCA is mineralized the fluoride, carbonate, and formate ions. The 1H-perfluoroalkane undergoes the same degradation process at even lower temperatures. Computational studies identified the corresponding perfluoroalkenes as likely intermediates, and an authentic standard of the seven-carbon perfluoroalkene is competent for the degradation.

FIG. 2. Overall reaction scheme, monitoring PFOA and CF₃CO₂⁻ concentrations over course of reaction, summary of degradation products from series of PFCAs of different lengths. A) Heating 0.089 M PFOA in 8:1 DMSO:H₂O with 30 equiv NaOH allows 90% of the initial fluorine to be recovered as inorganic fluoride, and residual trifluoroacetate with few other organofluorine byproducts. Formate ions (26 mol %) and several other non-fluorinated byproducts were identified (107±8 mol %). B) ¹⁹F NMR spectra from 0-24 h. Peaks corresponding to PFOA perfluoroalkyl fluorines between −115 and −126 ppm as well as at −80 ppm disappear in less than 24 h. Trifluoroacetate (−73.6 ppm) appears and disappears (disappearance shown in inset) more slowly over the course of the reaction. C) Amount of PFOA (solid line) and sodium trifluoroacetate (dashed line) in the reaction over time. Error bars correspond to standard deviation of three experiments. D) Fluoride recovery calculated as mols of fluoride after reaction as detected by ion chromatography/mols of fluorine in PFCA reactant. Formate/PFCA calculated as mols of formate as detected by IC after reaction/mols of PFCA reactant. CF₃CO₂⁻/PFCA calculated as mols CF₃CO₂⁻ as calculated from ¹⁹F NMR spectroscopy after 24 h of reaction/mols PFCA reactant. All measurements expressed as average of three trials unless specified and error expressed as a standard deviation. All reaction times 24 hours unless specified. ^{a}286 hours, single measurement, ^{b}63%±12% of PFPrA starting material degraded after 24 h.

FIG. 3A. Proposed mechanism for PFCA degradation mechanism, with activation energies (ΔG^{‡}, kcal/mol) for each step as calculated at the M06-2X/6-311+G (2d,p)-SMD(DMSO) level. Cycle AD shows a three-carbon shortening of the original perfluorocarboxylic acid of n carbons (“1,” top) with one carbon lost as CO₂ (converted to CO₃²⁻ under basic conditions) and two carbons lost to fluoroacetic acid, which readily degrades under these reaction conditions. Pathway B shows the reaction that results from the 1,2 addition of hydroxide to the carboxyl carbon of INT6. The alkene INT13 becomes protonated and proceeds through a similar pathway to Pathway A. At INT18, the aldehyde analogue of acid fluoride INT6, 1,2 addition to the carboxyl carbon leads to the formation of formate via elimination in Pathway C, whereas 1,4 addition to the β carbon leads back to Pathway D. All energies expressed in units of kcal/mol. * and ** indicate where FIG. 3a meets up.

FIG. 3B. Proposed mechanism for branched perfluoroether carboxylic acid degradation. Pathway A shows the branched CF₃ defluorinating in the same manner as PFCAs in FIG. 3. The lack of γ-fluorines forces formation of 5 via Pathway E, observed by NMR and MS. Calculations show the hydroxide-mediated S_{N}2 that eliminates the perfloroalkoxide tail in Pathway F, leading to the formation of a perfluorocarboxylic acid that is degraded according to the mechanism set out in FIG. 3A. All energies expressed in units of kcal/mol.

FIG. 4. Appearance and disappearance of perfluoropropionic acid (PFPrA) during the degradation of PFOA at 120° C. as a function of reaction time. Bottom spectrum: authentic sample of PFPrA and NaOH heated to 120° C. for 1 h. Peaks corresponding to trifluoroacetate (TFA) are highlighted in grey below TFA, peaks corresponding to PFOA are highlighted in grey and indicated by arrows, and peaks corresponding to PFPrA highlighted in grey and indicated by arrows. PFPrA is observed as a trace byproduct (in the 10 h spectrum, its concentration is approximately 1-2% of the initial PFOA concentration) that subsequently degrades between reaction times of 24-57 h.

FIG. 5. Kinetic trace of the degradation of CF₃CO₂Na over time as calculated by NMR concentration. CF₃CO₂Na (0.089 M in DMSO) was degraded at 120° C. with 30 equiv NaOH in 8:1 DMSO:H₂O.

FIG. 6. ¹H NMR spectra of formate formation over time at 120° C. Peaks highlighted gray are 4,4′-difluorobenzophenone standard, peaks highlighted are formate. A) PFOA degradation reaction over time. Formate increases steadily over the course of the reaction, even after all PFOA has been degraded (24 h) and only TFA remains. B) Control reaction of water, DMSO, and NaOH without PFOA shows that at long time periods, DMSO can react with base to create formate. In both cases, formate production was confirmed by ion chromatography.

FIG. 7. Rates of PFCA degradation, as measured by ¹⁹F NMR integration of the respective alpha-carbon fluorine resonances of each PFCA.

FIG. 8. Kinetic trace of mols of trifluoroacetate per mol of reactant PFCA, as measured by ¹⁹F NMR spectroscopy. For TFA itself, the plot indicates its degradation rate. For PFPrA and PFBA, little or no TFA is formed. For PFCAs with five or more carbons, approximately 0.3 mol TFA/mol PFCA are formed in the early stages of the degradation reaction.

FIG. 9. ¹⁹F. NMR spectra (600 MHZ) of aliquots from the 40° C. degradation of PFHp-1H. When the degradation is run at this lower temperature, various fluorinated intermediates (fluoroacetic acid, INT8/9, perfluoropentanoic acid) are observed that are not seen in the spectra of degradation reactions run at higher temperatures. These intermediates are shown in greater detail below. TFA=trifluoroacetate, ES=external standard (4,4′-difluorobenzophenone), FAA=fluoroacetic acid.

FIG. 10. Disappearance of PFOA over time at three different reaction temperatures as measured by ¹⁹F NMR. [PFOA]=0 mmol at <24 h at 120° C. (average of triplicates), 100 h at 100° C. (average of triplicates), and >290 h for 80° C., showing the high temperature-dependence of the rate-limiting step.

FIG. 11. ¹⁹F NMR spectra (600 MHZ) of aliquots from the 40° C. degradation of S1. When the degradation is run at this lower temperature, various fluorinated intermediates (fluoroacetic acid, INT8/9, perfluorobutanoic acid) are observed that are not seen in the spectra of degradation reactions run at higher temperatures. These intermediates are shown in greater detail below. TFA=trifluoroacetate, ES=external standard (4,4′-difluorobenzophenone), FAA=fluoroacetic acid.

FIG. 12. Partial ¹⁹F NMR spectra (600 MHZ) of the 40° C. degradation of 2. In the first few hours of reaction, an intermediate with 3 CF₂ groups is observed. We hypothesize that this intermediate is INT8 or 9 indicated peaks are highlighted with arrows. In spectra obtained at 24 h, 77 h, and 142 h, resonances corresponding to five-carbon PFPeA are observed (highlighted peaks corresponding to CF₃(CF₂)₃ are indicated with arrows), in accordance with the three-carbon shortening process proposed in FIG. 3A Pathways A+D.

FIG. 13. Partial ¹⁹F NMR spectra (600 MHZ) degradation of S1 performed at 40° C. In the first few hours of reaction, an intermediate with 3 CF₂ groups is observed (purple). We hypothesize that this intermediate is INT8 or 9; see FIG. S18 for further assignment of these peaks. In spectra obtained at 24 h, 77 h, and 142 h, resonances corresponding to four-carbon PFBA are observed (blue), in accordance with the three-carbon shortening process proposed in FIG. 3 Pathways A+D. A peak corresponding to perfluoropropionic acid (PFPrA) indicated with arrows.

FIG. 14. ¹⁹F NMR spectra of 0.089 M perfluorooctanoic acid (PFOA) in water with 30 equiv NaOH heated to 120° C. No change in the spectra over time shows that this decarboxylation needs polar aprotic solvent to occur. 4,4′-difluorobenzophenone standard is crossed out.

FIG. 15. Fluorine balance of PFOA degradation performed at 120° C. at different reaction times. Organofluorine content (black dashed line) was measured by integrating all ¹⁹F NMR peaks; the fluoride ion (black solid line) were measured by ion chromatography of entire reaction solution. The total fluorine (gray line) is calculated by adding the organofluorine and fluoride ion amounts and remains close to unity throughout the PFOA degradation reaction, indicating little to no loss of volatile organofluorine products.

FIG. 16. GCMS-headspace total ion chromatograms after 4 hours of reaction for GenX (top), perfluoropropionic acid (second from top), 4 (second from bottom), perfluoropentanoic acid (bottom). Both PFPrA and GenX show evidence of CF₃CF₂^{+⋅} gas fragments, presumably derived from CF₃CF₂H, whereas PFPeA and 4 show only CF₃^{+⋅} fragments, presumably from an equilibrium between CF₃COOH and CF₃H.

FIG. 17. Quantitative ¹³C NMR of isolated reaction precipitate dissolved in D₂O [sodium acetate was used as an internal standard, (50 μL of a 0.68 M solution in D₂O). The PFOA sample was recorded with 900 scans at 40 s delay. Samples other than PFOA were recorded with 300 scans at 40 s delay and have imperfect proton decoupling from the extreme pH sample conditions. Sodium trifluoroacetate (TFA) shows only carbonate (168 ppm) as reaction byproduct. PFBA shows carbonate, trace oxalate ion formation, and enhanced tartronate ion formation compared to other samples. PFPeA shows glycolate (180 ppm, 61 ppm), tartronate, oxalate, and carbonate ion formation. PFHxA shows glycolate, oxalate, formate (present in proton NMR, ion chromatography, hard to see here due to proton coupling), and carbonate. PFOA shows glycolate, tartronate, oxalate, formate, carbonate, and two trace unknown peaks at 178 and 69 ppm. *Tartronate assigned based on literature.

FIG. 18. ¹⁹F NMR spectra of degradation of GenX over time at increasing temperature stages. Starting material for GenX (top, shaded dots) disappear as GenX is converted to compound 5 and falls out of solution, presumably because of an insoluble intermediate that is converted to intermediate 5 over time, causing 5 to slowly increase in concentration (filled grey dots, until 120 h). When the temperature is increased to 80° C. (121 h), peaks corresponding to PFPrA (middle, grey filled dots) appear from 5 degradation as predicted, then disappear more quickly after the temperature is increased to 120° C. (289 h).

FIG. 19. ¹⁹F NMR spectra of GenX degradation reaction at 120° C. The starting material (added as GenX ammonium salt) quickly decarboxylates and proto-de-trifluoromethylates to intermediate 5, which was also detected by ESI-MS. Over the course of several hours, 5 degrades to PFPrA, which subsequently degrades further, mainly to CF₃CF₂H, as described for the degradation of PFPrA (FIG. 2, FIG. 20).

FIG. 20. ¹⁹F NMR spectra of the degradation of perfluoropropionic acid (top) after 22 hours and GenX (bottom) after 24 hours at 120° C. Peaks corresponding to the same compounds appear in the degradation of each, indicating that GenX degrades to PFPrA and then follows the PFPrA degradation pathway, including producing CF₃CF₂H, which volatilizes and does not defluorinate, resulting in a lower fluoride recovery than for longer-chain analogues. Identity of CF₃CF₂D hypothesized.

FIG. 21. ¹⁹F NMR spectra of 4 degradation reaction at 120° C. The starting material (added as 4 ammonium salt) quickly decarboxylates and proto-de-trifluoromethylates to intermediate S2, which was also detected by APCI-MS. Over the course of several hours, S2 degrades to PFPeA, which subsequently degrades further, mainly to fluoride and CF₃CO₂⁻, as described for the degradation of PFPeA (FIG. 2).

FIG. 22. ⁹F NMR spectra of degradation of 4 over time at increasing temperature stages. Starting material for 4 (top, shaded dots) disappear as 4 is converted to intermediate S2 and falls out of solution, presumably because of an insoluble intermediate that is converted to intermediate S2 over time, causing S2 to slowly increase in concentration (brightly colored dots, until 120 h). When the temperature is increased to 80° C. (121 h), peaks corresponding to PFPeA (brown dots) and trifluoroacetate appear from S2 degradation as predicted, then disappear more quickly after the temperature is increased to 120° C. (289 h).

### DETAILED DESCRIPTION OF THE INVENTION

Disclosed herein are methods for mineralizing a perfluoroalkyl and polyfluoroalkyl substance (PFAS). The disclosed technology can leverage the removal of an anionic moiety, such as through decarboxylation, and low-barrier defluorination mechanisms to mineralize PFAS at mild temperatures with high defluorination and low organofluorine side product formation. The conditions described here can destroy concentrated solutions of PFAS, give high fluoride ion recovery and low byproduct formation, and operate under relatively mild conditions with inexpensive reagents.

PFAS is a group of man-made chemicals characterized by a strong bond between fluorine and carbon. Because of this strong bond, PFAS provides resilience and durability. These properties are useful to the performance of hundreds of industrial applications and consumer products such as carpeting, apparels, upholstery, food paper wrappings, wire and cable coatings, and in the manufacturing of semiconductors.

Perfluoroalkyl substances comprise fully fluorinated alkyl moieties. Many perfluoroalkyl substances comprise a straight or branched chain (or tail) of two or more carbon atoms with a charged functional group (or head) attached at one end. Common charged functional groups include anionic functional groups, such as carboxylates or sulfonates, but other forms are also detected in the environment.

Polyfluoroalkyl substances are distinguished from perfluoroalkyl substances by not being fully fluorinated. Instead, they are aliphatic substances for which all hydrogen atoms attached to at least one (but not all) carbon atom have been replaced by fluorine atoms, in such a manner that they contain the perfluoroalkyl moiety CₙF₂ₙ₊₁.

Biotic and abiotic degradation of PFAS may result in the formation of perfluoroalkyl acids (PFAAs). As a result, PFAAs are sometimes referred to as “terminal PFAS” or “terminal degradation products,” meaning no further degradation products will form from them under normal environmental conditions. PFAS that degrade to create PFAAs may be referred to as “precursors.” PFAAs are divided into two major subgroups.

Perfluoroalkyl carboxylic acids (PFCAs), and their deprotonated forms, are PFAS that may be terminal degradation products of some precursor polyfluoroalkyl substances, such as fluorotelomer alcohols (FTOHs). Exemplary PFCAs include compounds of formula CF₃(CF₂)ₙCOOH. The integer n may be any number, but in some embodiments is an integer from 0 and 18. Exemplary perfluoroalkyl carboxylic acids are provided in Table 1.

TABLE 1
Exemplary perfluoroalkyl carboxylic acids

| | | | Molecular | |
|---|---|---|---|---|
| | | Molecular | weight | |
| Name | Abbreviation | formula | (g/mol) | CAS No. |
| Trifluoroacetic acid | TFA | CF₃COOH | 114.02 | 76-05-1 |
| Perfluoropropanoic acid | PFPrA | C₂F₅COOH | 164.03 | 422-64-0 |
| Perfluorobutanoic acid | PFBA | C₃F₇COOH | 214.04 | 375-22-4 |
| Perfluoropentanoic acid | PFPeA | C₄F₉COOH | 264.05 | 2706-90-3 |
| Perfluorohexanoic acid | PFHxA | C₅F₁₁COOH | 314.05 | 307-24-4 |
| Perfluoroheptanoic acid | PFHpA | C₆F₁₃COOH | 364.06 | 375-85-9 |
| Perfluorooctanoic acid | PFOA | C₇F₁₅COOH | 414.07 | 335-67-1 |
| Perfluorononanoic acid | PFNA | C₈F₁₇COOH | 464.08 | 375-95-1 |
| Perfluorodecanoic acid | PFDA | C₉F₁₉COOH | 514.08 | 335-76-2 |
| Perfluoroundecanoic acid | PFUnDA | C₁₀F₂₁COOH | 564.09 | 2058-94-8 |
| Perfluorododecanoic acid | PFDoDA | C₁₁F₂₃COOH | 614.10 | 307-55-1 |
| Perfluorotridecanoic acid | PFTrDA | C₁₂F₂₅COOH | 664.10 | 72629-94-8 |
| Perfluorotetradecanoic | PFTeDA | C₁₃F₂₇COOH | 714.11 | 376-06-7 |
| acid | | | | |

Perfluoroalkane sulfonic acids (PFSAs), or their deprotonated forms, are PFAS that may be terminal degradation products of select precursor polyfluoroalkyl substances, such as perfluoroalkyl sulfonamido ethanols (FASEs). Exemplary FASEs include compounds of formula CF₃(CF₂)ₙSO₃H. The integer n may be any number between 0 and 18. An example of a PFSA is PFOS.

Perfluoroalkyl ether carboxylic acids (PFECAs) and perfluoroalkyl ether sulfonic acids (PFESAs), and deprotonated forms thereof, are another subclass of PFAS. PFECAs and PFESAs include ether C—O bonds as well as C—F bonds. Exemplary perfluoroalkyl ether carboxylic acid include without limitation, is ammonium hexafluoropropylene dimer acid (HFPO-DA; also known by the trade name GenX or FRD-903; CAS No. 62037-80-3), 3H-perfluoro-3-[(3-methoxy-proproxy)propionic acid (ADONA; CAS No. 958445-44-8), or perfluoro[(2-ethyloxy-ethoxy)acetic acid] (EEA, CAS No. 908020-52-0).

PFAS may also include perfluoroalkane and perfluoroalkenes. Perfluoroalkanes and perfluoroalkenes include, without limitation, perfluoro-1H-alkanes and perfluoro-1H-alkenes, respectively. Perfluoroalkanes and perfluoroalkenes may include, without limitation, compounds of formula CF₃(CF₂)ₙH and CF₃(CF₂)ₙCFCF(CF₂)ₘH, respectively. The integers n and m may be any number, but in some embodiments is an integer from 0 and 18. An exemplary perfluoroalkane is perfluoro-1H-heptane and an exemplary prefluoroalkene is perfluoro-1H-heptene, which are utilized in the Examples.

Methods for mineralizing a PFAS are provided. The method may comprise heating a solution comprising the PFAS, a base, and a polar aprotic solvent to an effective mineralization temperature. The PFAS may also comprise a single PFAS compound or a mixture of two or more different PFAS compounds. The PFAS compounds for use in the methods described herein include any PFAS compound that can be mineralized under the conditions described herein. The PFAS compounds mineralized under the conditions described herein may include, without limitation, perfluoroalkyl carboxylic acids (PFCAs), perfluoroalkyl ether carboxylic acids (PFECAs), perfluoro-1H-alkanes, or perfluoro-1H-alkenes.

The solution comprising the PFAS also comprises a base and a polar aprotic solvent. Polar aprotic solvents are polar solvents that lack an acidic proton. An exemplary polar aprotic solvent is dimethyl sulfoxide (DMSO), dimethylacetaminde (DMAc), or sulfolane.

The solution may optionally comprise water. In some embodiments, the relative proportion of polar aprotic solvent to water may be from about 25:1 to about 1:1, about 20:1 to about 1:1 or about 15:1 to about 1:1 v/v. In some embodiments, the solution may comprise another polar protic solvent.

The base may be selected from a variety of different bases so long as it does not interfere with PFAS mineralization. Exemplary bases include metal hydroxides, such as sodium hydroxide (NaOH) or potassium hydroxide (KOH). The relative ratio of base to PFAS may be varied between about 1:1 to about 50:1, about 10:1 to about 50:1, or about 20:1 to about 40:1 equivalents of the base to PFAS.

The effective mineralization temperature may be between about 40-180° C., 60-160° C., 80-140° C., or 80-120° C. In some embodiments, the effective mineralization temperature may be 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99, 100, 101, 102, 103, 104, 105, 106, 107, 108, 109, 110, 111, 112, 113, 114, 115, 116, 117, 118, 119, 120, 121, 122, 123, 124, 125, 126, 127, 128, 129, 130, 131, 132, 133, 134, 135, 136, 137, 138, 139, 140, 141, 142, 143, 144, 145, 146, 147, 148, 149, 150, 151, 152, 153, 154, 155, 156, 157, 158, 159, 160° C. or a temperature between any two of the foregoing.

As demonstrated in the Examples, fluorine may be recovered as fluoride ion. In some embodiments, at least half of the PFAS fluorine is recovered as fluoride ion. In some embodiments, between 60-100%, 65-100%, 70-100%, 75-100%, 80-100%, 85-100%, 90-100%, or 95-100% is recovered as fluoride ion.

Concentrated solutions of PFAS may be used as the source for PFAS mineralization. As used herein, a “concentrated solution of PFAS” means as solution where the concentration of PFAS is increased by a chemical, mechanical, or industrial process. One means of preparing a concentrated solution includes the use of an absorbent. The opportunity to degrade PFAS at high concentrations in aqueous and non-aqueous solvents may be facilitated through PFAS adsorbents that can be regenerated by a simple solvent wash. Absorbents suitable for use to concentrate PFAS may include activated carbons, ion-exchange resins, or cross-linked polymers, such as cross-linked cyclodextrin polymers. For example, cross-linked cyclodextrin polymers can adsorb ppb-ppt concentrations of PFAS from water and then be regenerated with an alcohol wash to quantitatively recover PFAS in a concentrated waste stream that would be amenable to mineralization. Other processes can be used to prepare a concentrated solution of PFAS. For example, concentrated PFAS waste streams may also be found as the rejection streams from reverse osmosis, solid or liquid byproducts of industrial products, or from commercial products that contain PFASs. By eliminating a dilute, aqueous environment, perfluorocarbon and carboxylic acid reactivity can be exploited in an organic synthetic manner under a broader range of reaction condition to mineralize PFAS contaminated liquids.

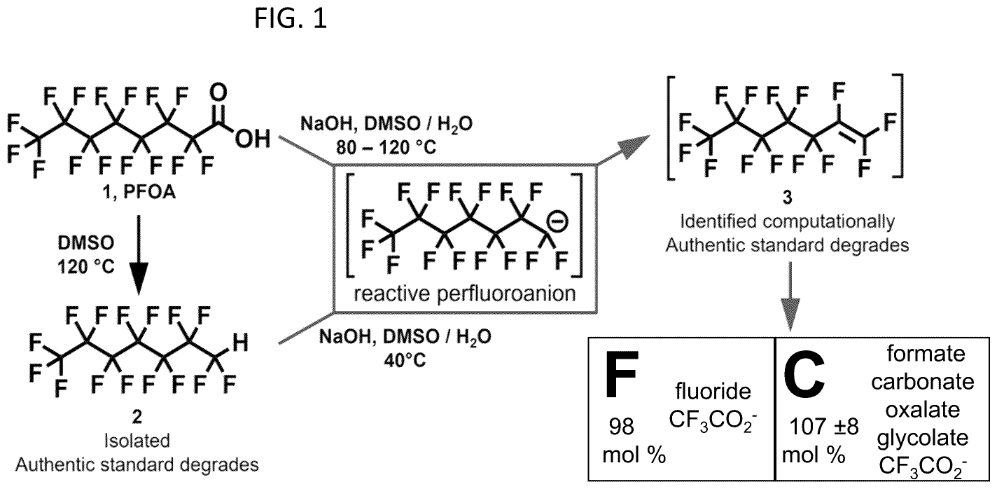

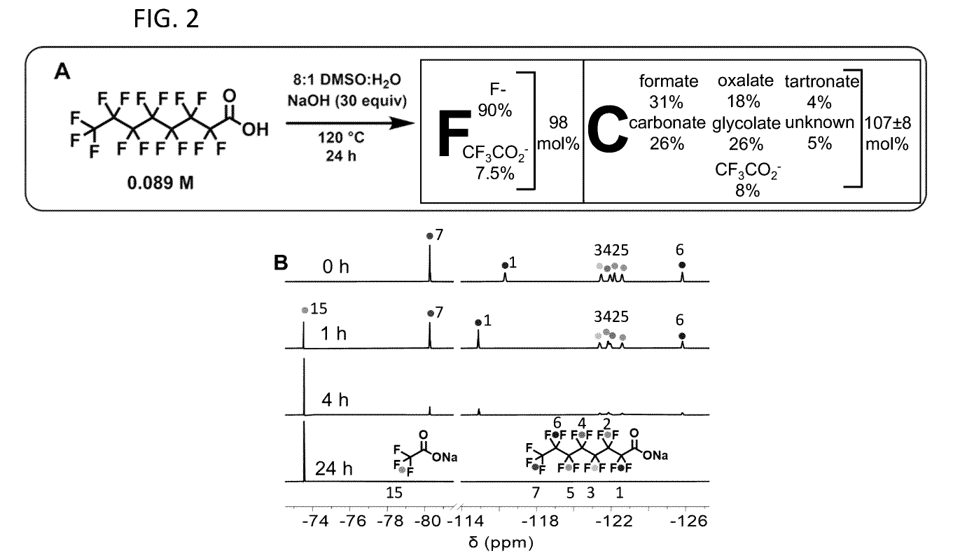

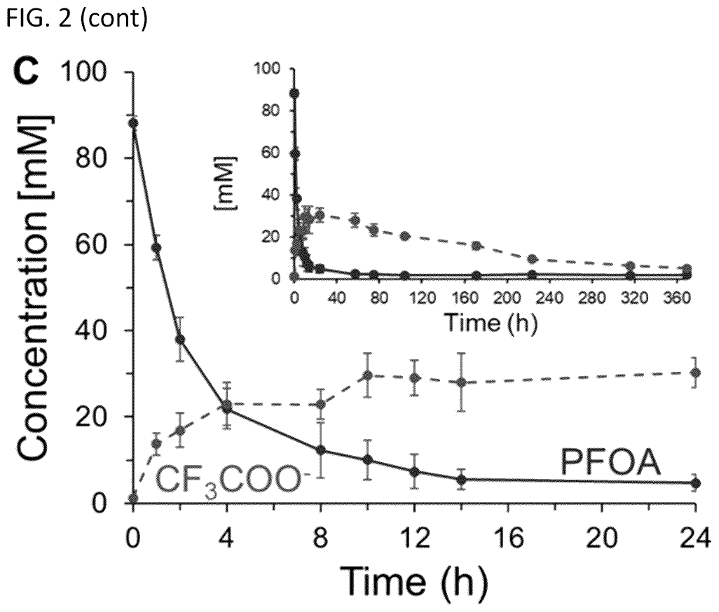

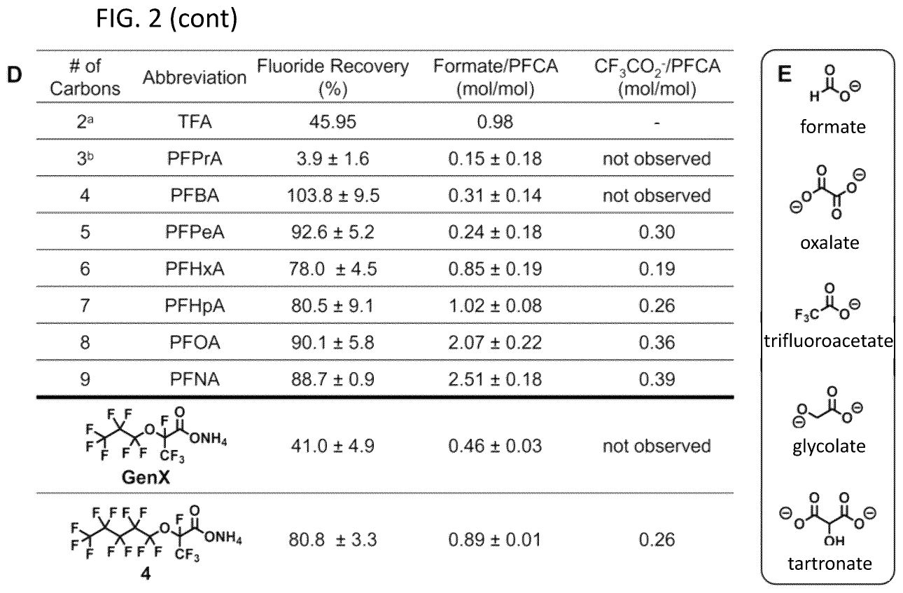

Reactive perfluoroalkyl anions that are mineralized under mild conditions by decarboxylating perfluorocarboxylic acids (PFCAs) and perfluoroalkyl ether carboxylic acid (PFECAs), some of the largest classes of PFAS compounds, at low temperatures in dipolar aprotic solvents. The Examples demonstrated that PFCAs of various chain lengths undergo efficient mineralization in the presence of NaOH in mixtures of water and DMSO at mild temperatures (80-120° C.) and ambient pressure (FIG. 1). Under these conditions, perfluorooctanoic acid (PFOA, 1) is completely degraded with greater than 90% defluorination and minimal formation of fluorocarbon byproducts (FIG. 2A). Experimental observations and density functional theory calculations offer strong evidence for degradation pathways distinct from the single-carbon chain-shortening processes. This previously unrecognized reactivity, which is accessible at moderate temperatures and ambient pressure, is immediately promising for PFCA destruction and can be used for deconstruction of other PFAS classes having activated polar groups.

As the Examples demonstrate, reactive and readily degradable perfluorocarbanions are easily accessed by decarboxylating PFCAs in dipolar aprotic solvents. In a solution of dimethyl sulfoxide (DMSO) and H₂O (8:1 v/v) at 120° C., perfluorooctanoic acid (PFOA) decarboxylates to form perfluoro-1H-heptane 2, which phase-separates from solution as an oil. ¹H, ¹³C, and ¹⁹F NMR spectroscopy of the isolated oil confirmed the formation of the decarboxylated product in high purity (data not shown). The lower barrier to decarboxylation may be induced by solvent effects from the polar aprotic solvent.

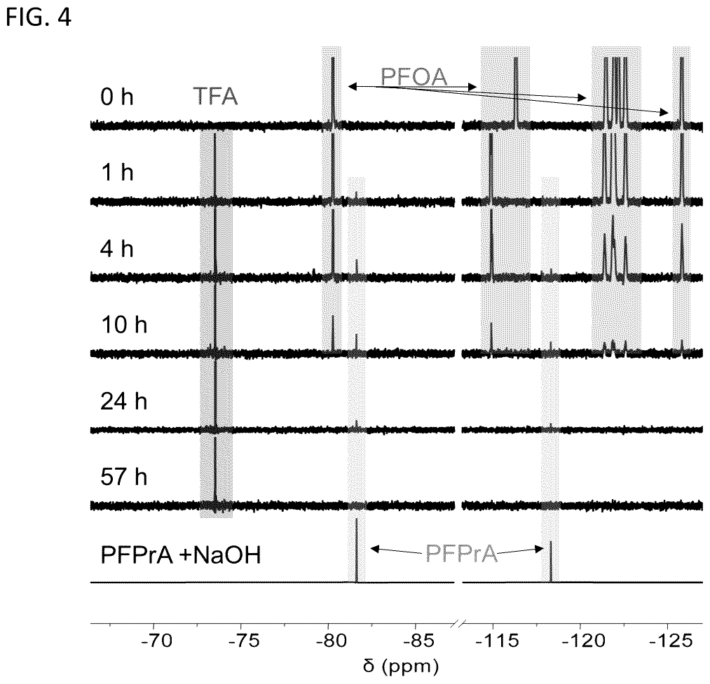

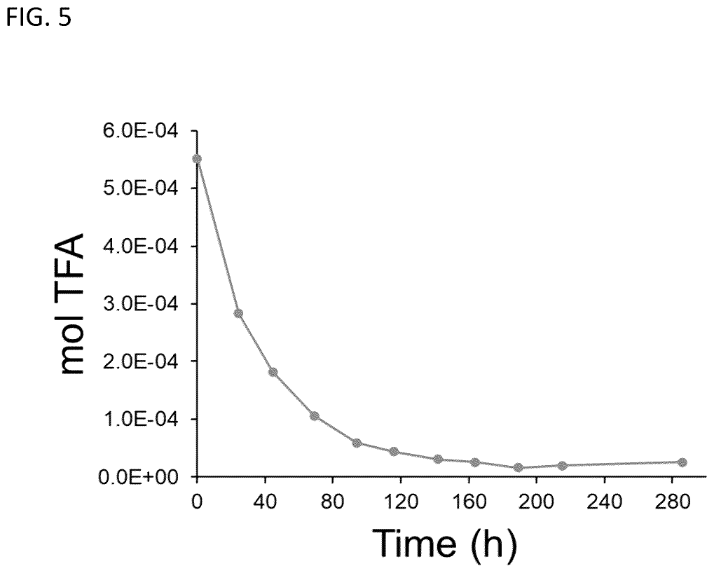

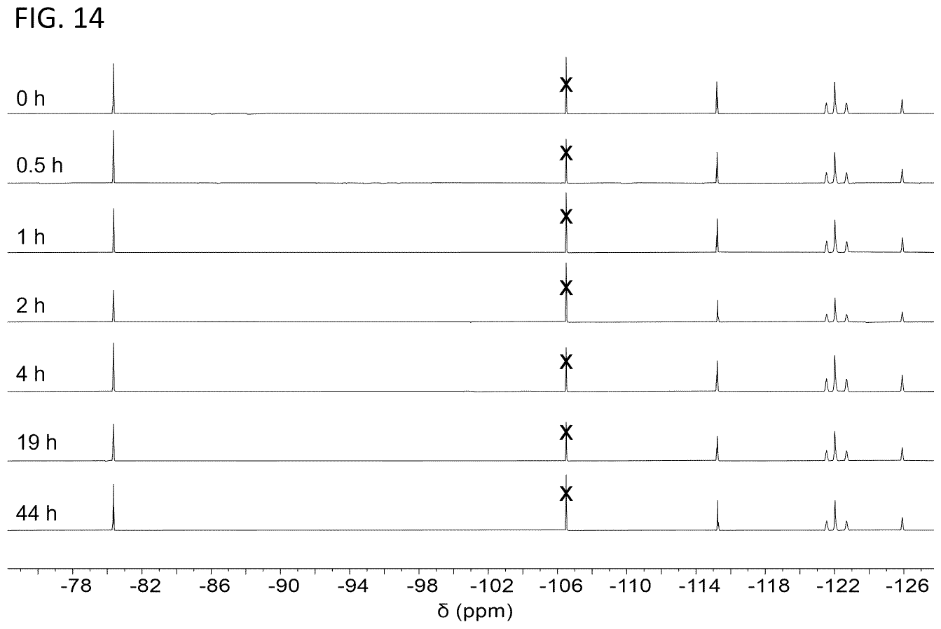

The Examples also demonstrate that a PFOA solution in DMSO/H₂O subjected to the decarboxylation conditions but in the presence of a base, such as NaOH (30 equiv), degraded to a mixture of fluoride, trifluoroacetate ions, and carbon-containing byproducts (FIG. 2A). Degradation also occurs in other polar aprotic solvents such as dimethylacetamide and sulfolane, but it does not proceed in pure water (FIG. 14, Table 3). ¹⁹F NMR spectroscopy of reaction aliquots collected over 24 hours indicated resonances corresponding to PFOA were no longer detectable within 14 hours. Few fluorinated intermediates were observed in these spectra. No resonances corresponding to perfluoroalkyl groups containing between four and seven carbons were observed in any of the spectra. Resonances corresponding to sodium perfluoropropionate (CF₃CF₂CO₂Na) at −81.5 ppm and −118.2 ppm were observed just above the baseline within spectra of aliquots collected at reaction times shorter than 24 hours, and then are absent in spectra of later aliquots (FIG. 4). The only prominent fluorine resonance in the aliquot sampled at 24 hours corresponds to sodium trifluoroacetate (CF₃CO₂Na, −73.6 ppm, FIG. 2B). Integration of this resonance indicated that its intensity plateaus around 4-24 hours, corresponding to only 7% of the F content and 9% of the C content relative to the initial PFOA concentration (FIG. 2A, 2C). However, resonances corresponding to CF₃CO₂Na ions eventually decrease in intensity and presumably degrade into fluoride, albeit much more slowly than the rate of PFOA disappearance (FIG. 2C, inset). The CF₃CO₂Na ion resonances disappear over 300 hours, which we confirmed by subjecting an authentic sample of sodium trifluoroacetate to the same reaction conditions (FIG. 5). These observations indicate that PFOA degradation is rapid and forms CF₃CO₂Na and trace CF₃CF₂CO₂Na as the only identifiable perfluoroalkyl-containing liquid-phase byproducts, each of which continues to degrade over extended reaction times. Subjecting perfluorooctane sulfonate ions (PFOS) to the basic decarboxylation conditions does not result in decreasing perfluoroalkyl ¹⁹F NMR integrations or fluoride formation (Table 3), indicating decarboxylation to the reactive anion intermediate is the key first step of the defluorination process for PFCAs.

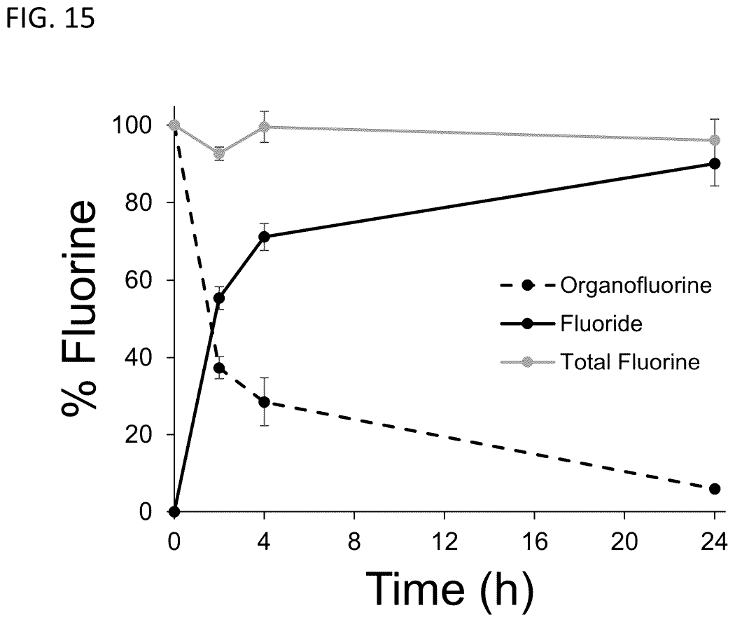

Ion chromatography of the reaction mixtures after PFOA degradation accounts for a high mass balance of fluorine in the PFOA degradation reaction. The heterogenous reaction mixture was diluted with water until all precipitated salts dissolved, then the mixture was analyzed using ion chromatography. 90±6% of the fluorine atoms originating from the PFOA were recovered as fluoride ions after 24 h of reaction at 120° C. Control experiments showed that the fluorinated PTFE reaction vessels did not contribute a significant amount of fluoride to the fluoride recovery (Table 3). Fluoride analyses performed at shorter reaction times (FIG. 15) indicated that the fluoride increased proportionally to the decrease in [PFOA], as measured by ¹⁹F NMR spectroscopy. This high fluoride recovery indicates that most of the perfluoroalkyl fluorines are defluorinated and mineralized rather than being transformed to smaller-chain PFAS or being lost as volatile fluorocarbons.

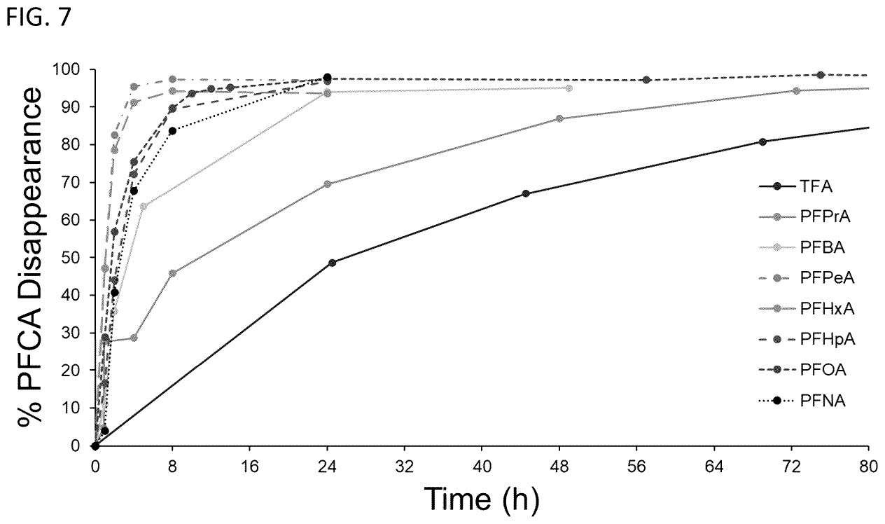

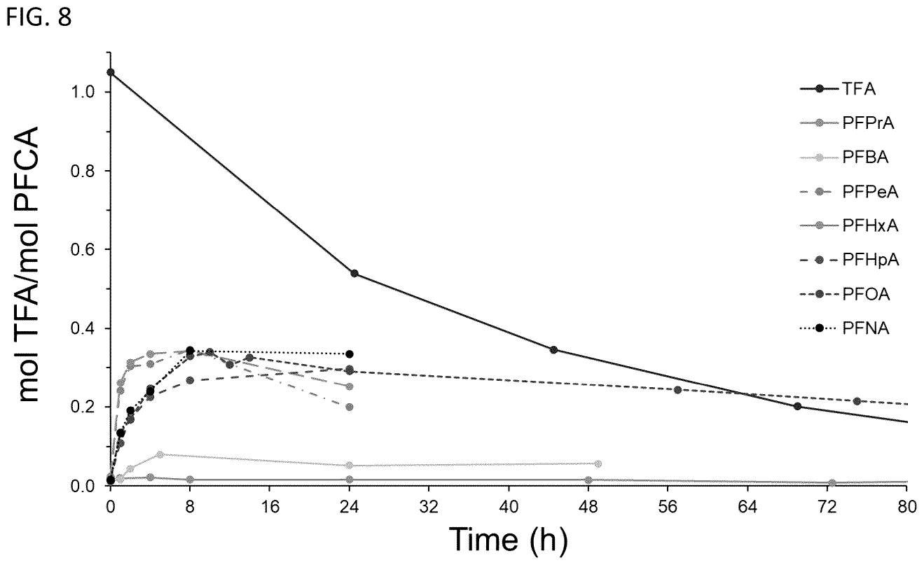

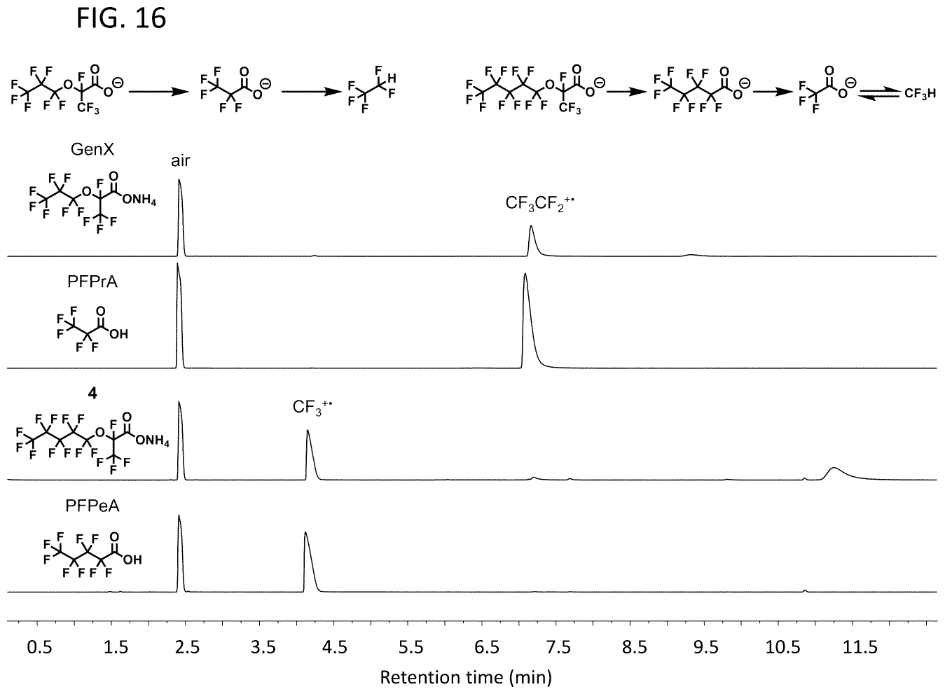

PFCAs with different chain lengths (2-9 carbons) were degraded, which provided fluoride recoveries between 78% and quantitative at 24 hours for all PFCAs with four or more carbons (FIG. 2D). Although the longer-chain (C≥4) PFCAs have a similar degradation profile to PFOA in that their perfluoroalkyl peaks disappeared from the ¹⁹F NMR spectra (FIG. 7) and CF₃CO₂ was formed (FIG. 2D, FIG. 8), the destruction of shorter-chain PFCAs (C=2, 3) is slower and appears to occur by different mechanisms. For trifluoroacetate (C=2), degradation is slow (>6 days, see FIG. 5) likely because the instability of the CF₃⁻ anion (28) hinders decarboxylation, such that destruction occurs either more slowly or by a different mechanism. The carbanion corresponding to PFPrA (C=3) decarboxylation is similarly unstable (28), resulting in degradation faster than trifluoroacetate but slower than the longer PFCAs (FIG. 7). Although the PFPrA ¹⁹F NMR peaks disappear completely over three days, fluoride recovery is lower than other PFCAs (3.9±1.6%, FIG. 2D). PFPrA, unlike others in the series, decarboxylates to form a volatile product; in the ¹⁹F NMR for PFPrA degradation, peaks corresponding to CF₃CF₂H can be identified (data not shown). Headspace gas chromatography/electron-impact mass spectrometry also detected the CF₃CF₂^{+⋅} fragment in the gas phase of the reaction (FIG. 16). This finding was corroborated by atmospheric pressure chemical ionization-mass spectrometry of a liquid aliquot of the reaction that had a prominent peak corresponding to CF₃CF₂⁻ (data not shown). It appears to be more favorable to produce volatile CF₃CF₂H than for the C=3 PFCA to proceed down the destruction pathway; as discussed below, this supports our proposal that a γ-carbon is necessary for the major defluorination pathway to occur. Previous PFAS degradation studies have suggested that PFCAs (or other PFAS that are PFCA precursors) degrade through a decarboxylation-hydroxylation-elimination-hydrolysis (DHEH) pathway in which each perfluorocarboxylic acid is shortened by one carbon each cycle, producing successively shorter PFCAs. However, the non-conformal degradation of the three-carbon acid and the products observed in the ¹⁹F NMR spectra of degradation reactions of PFCAs containing four or more carbons indicate that degradation instead occurs via distinct, non-single-carbon-shortening mechanisms under these conditions.

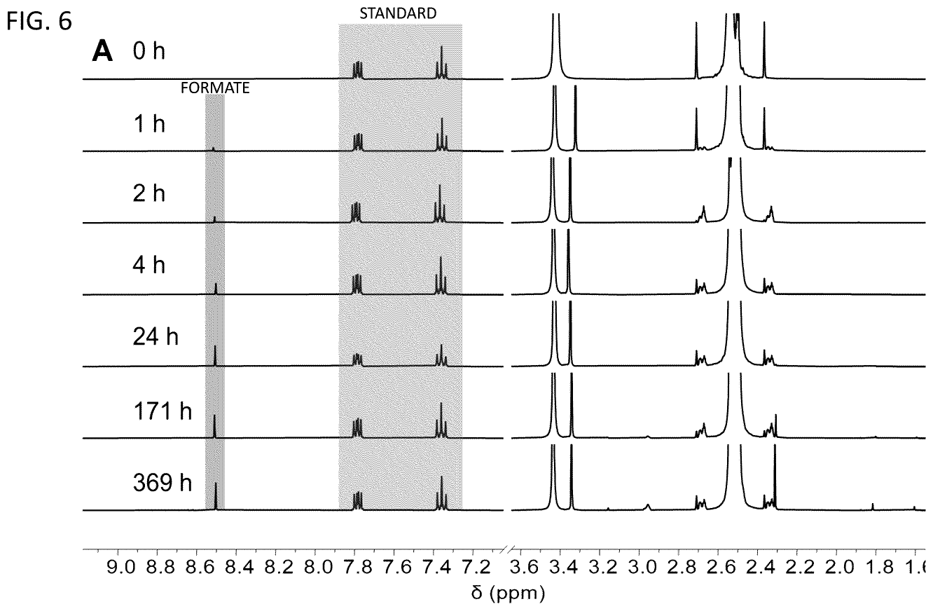

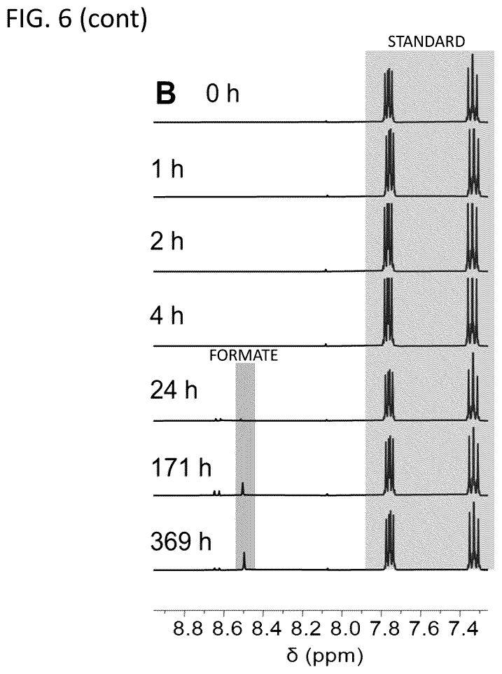

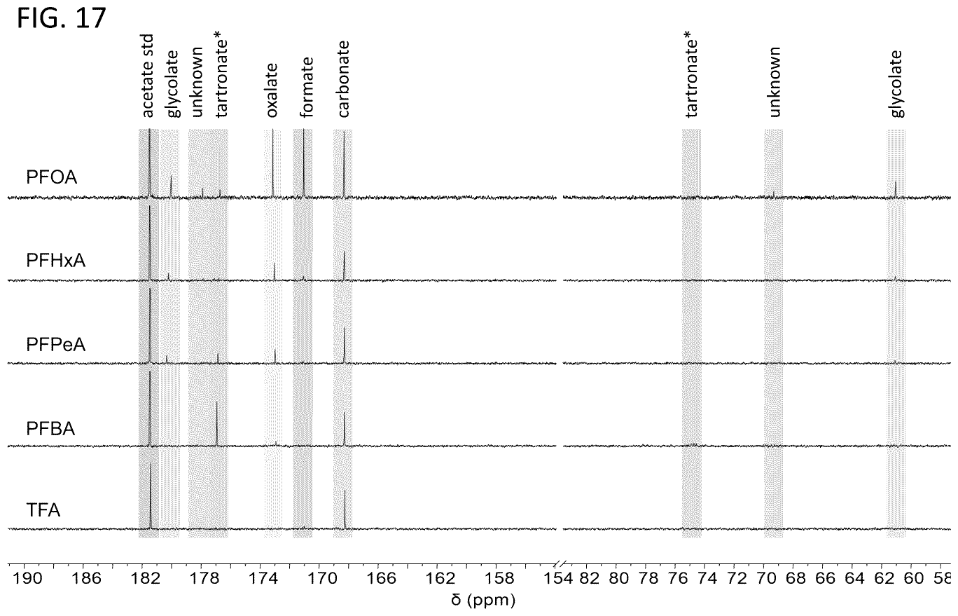

The hypothesis that degradation does not occur by iterative one-carbon shortening was further supported by quantifying the carbon-containing byproducts formed when PFOA was degraded for 24 h. These byproducts were quantified using a combination of solution ¹H and ¹⁹F NMR spectroscopy and quantitative ¹³C NMR spectroscopy of the precipitate isolated from the reaction and dissolved in D₂O. Furthermore, ion chromatography was performed on the combined solution and precipitate by adding water to the reaction mixture until the precipitate redissolved. Taken together, these measurements account for the complete carbon balance of the PFOA degradation (107±8 mol % C relative to the [PFOA]₀, Table 4, FIG. 17). Other than the residual CF₃CO₂⁻ ions described above, which continue to degrade at longer reaction times, no other organofluorine compounds were detected. Instead, one-, two-, and three-carbon products lacking C—F bonds were identified and quantified. Formate ions were found in solution (FIG. 6) and in the precipitate, corresponding to 2.5±0.3 mols of formate ions per mol of PFOA, as determined by combining the formate concentrations measured in the solution and precipitate by NMR spectroscopy. This amount is consistent with ion chromatography of the reaction mixture and redissolved precipitate, which provided 2.1±0.2 mols of formate per mol of PFOA. Carbonate ions were detected exclusively in the precipitate, corresponding to 2.1±0.3 mols per mol PFOA. The most likely source of carbonate ions is from the initial decarboxylation step, along with other downstream processes that generate carbon dioxide or single-carbon products at the same oxidation state. Two-carbon products, glycolate ions (0.6±0.1 mol/mol PFOA) and oxalate ions (0.7±0.1 mol/mol PFOA), were found in the precipitate, along with three-carbon-containing tartronate ions (0.2±0.1 mol/mol PFOA). The glycolate and oxalate ions were identified by ¹³C NMR spectroscopy by comparison to authentic standards. Tartronate ions were identified by a combination of ¹³C and ¹H NMR spectroscopy, which were consistent with literature reports (29), and showed the expected correlations in 2D NMR experiments (data not shown). Finally, a small amount of the PFOA carbon balance is found in an unknown product, which we assign as a secondary degradation product derived from the reaction of glycolate ions with other intermediates because it is formed in greater amounts when glycolic acid was included at the beginning of the PFOA degradation reaction. Identifying and quantifying these carbon products has important implications for PFOA degradation: first, the high recovery of products with no C—F bonds, along with the high fluoride ion recovery, confirm that these conditions efficiently mineralize PFCAs. Furthermore, identifying multiple two- and three-carbon byproducts further implicates mechanisms more complicated than iterative one-carbon shortening processes.

PFCAs of different lengths degrade by different pathways, as indicated by the distinct patterns in their formate and CF₃CO₂ formation. If the chain-shortening DHEH mechanism were operative, we would expect that resonances belonging to chain-shortened species would appear transiently in the ¹⁹F NMR spectra as longer-chain PFCAs speciated into a distribution of shorter-chain PFCAs. Instead, only ¹⁹F NMR peaks corresponding to CF₃CO₂⁻ and trace amounts of CF₃CF₂CO₂⁻ were detected, and the following byproduct patterns emerged: PFCAs containing four or fewer carbons do not produce any CF₃CO₂⁻, but all PFCAs containing more than four carbons produce roughly the same sub-stoichiometric amount of CF₃CO₂⁻: approximately 0.3 equivalents of CF₃CO₂⁻ per mol of PFCA. PFCAs containing fewer than six carbons do not produce substantial amounts of formate (See FIG. 2D), but PFCAs containing six or more carbons produce increasing amounts of formate, with C=6 and 7 producing around 1 equivalent of formate per PFCA, C=8 around 2 equivalents, and C=9 around 2.5 equivalents. These observations indicate that CF₃CO₂⁻ and formate production occur by distinct pathways.

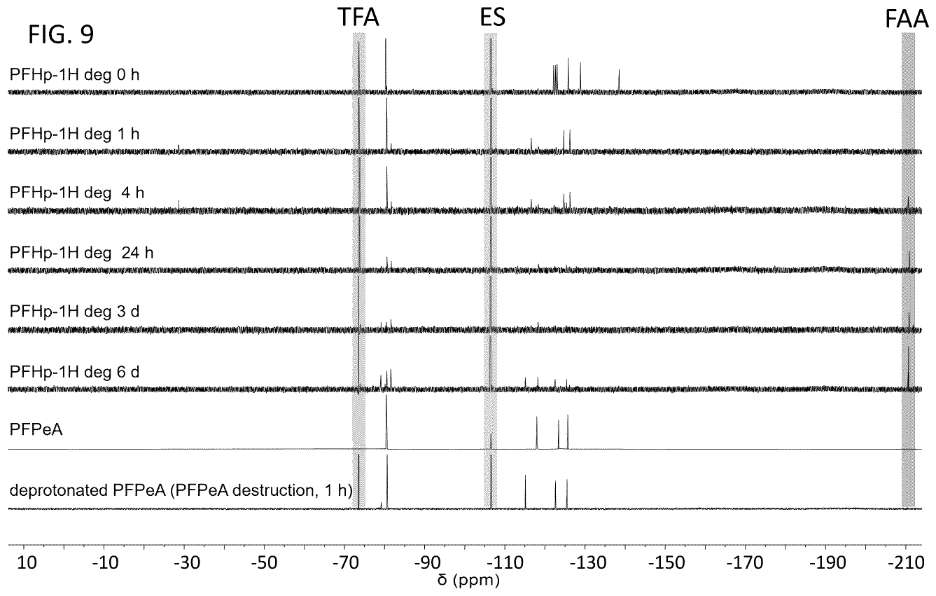

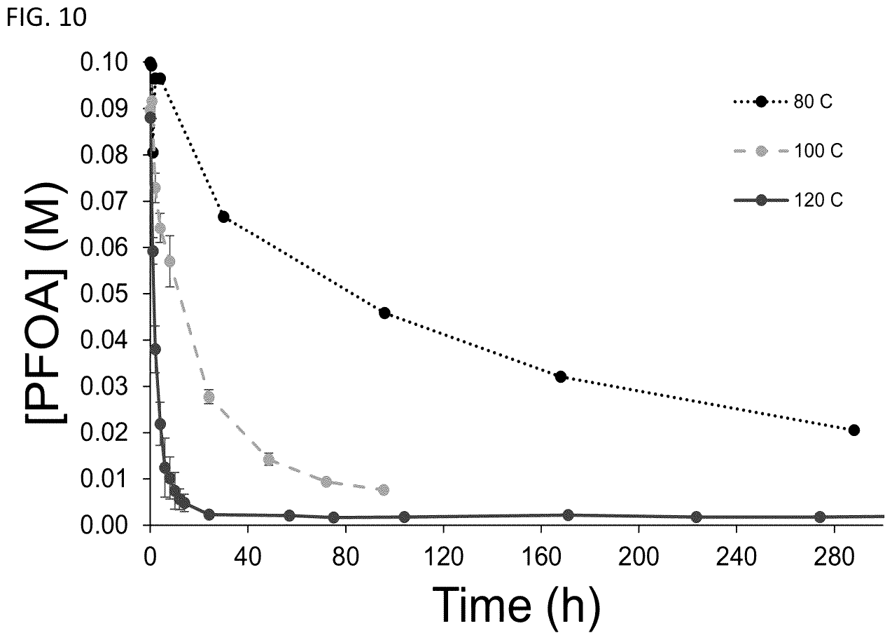

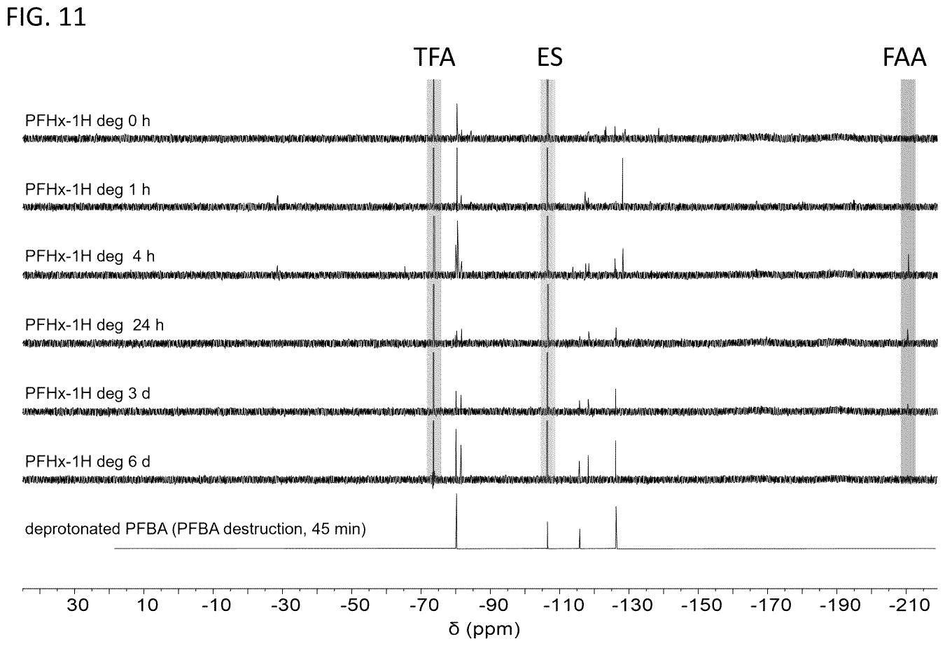

Experiments conducted at near-ambient temperatures show that decarboxylation is the rate-limiting step and subsequent defluorination and chain-shortening steps can occur at near-ambient temperature, giving experimental insight into the possible mechanism. Substantial defluorination still occurs when the isolated PFOA degradation product (perfluoro-1H-heptane 2) is subjected to degradation conditions but heated to only 40° C. (Table 3). PFCAs have historically been decarboxylated by heating PFCA salts in ethylene glycol at 190-230° C. to give perfluoro-1H-alkanes or by pyrolyzing PFCA salts at 210-300° C. to give perfluoro-1-alkenes, but dipolar aprotic solvent-assisted degradation enables decarboxylation at only 80-120° C., which can be followed by an even lower-temperature defluorination. When 2 was subjected to the basic degradation conditions, both fluoride and chain-shortened PFCAs are observed by IC and ¹⁹F NMR at short reaction times (5 minutes at 120° C.) as well as low temperatures (25 minutes at 40° C.), in contrast to reactions starting from the carboxylated PFOA at the same conditions, where no fluoride or short-chain PFCAs are formed at short reaction times or at low temperatures (Table 3). Degradation of 2 at 40° C. for 48 hours showed 57% defluorination (Table 3). Although the insolubility of the polyfluoroalkane standard in the DMSO/water solvent precluded accurate measurements of its concentration by NMR spectroscopy, the presence of the CF₃CO₂^{- 19}F NMR peak (FIG. 9) indicated that the decarboxylated material likely followed a similar degradation pathway. In this low-temperature experiment, intermediates that were not observed in the higher-temperature experiments became evident; notably, at around-210 ppm, a triplet with J=48 Hz appeared, which corresponds to the fluoroacetate ion (CH2FCOO⁻; FIG. 9). The fluoroacetate peak does not appear in the higher-temperature degradations because it degrades rapidly at those temperatures, as confirmed by the degradation of a pure standard. Temperature-dependent studies of the original PFOA degradation reaction showed that the reaction slowed slightly when the reaction was conducted at 100° C. (time to [PFOA]=0 approximately 100 hours as compared to 16 hours for 120° C., see FIG. 10) and slowed dramatically when lowered to 80° C. (>290 hours, FIG. 10). Therefore, significant defluorination of PFHp-1H was unexpected at 40° C. and suggests the steps following the decarboxylation are low-barrier or barrierless. These observations further indicate that the degradation does not proceed through successive chain-shortening via iterative decarboxylation steps.

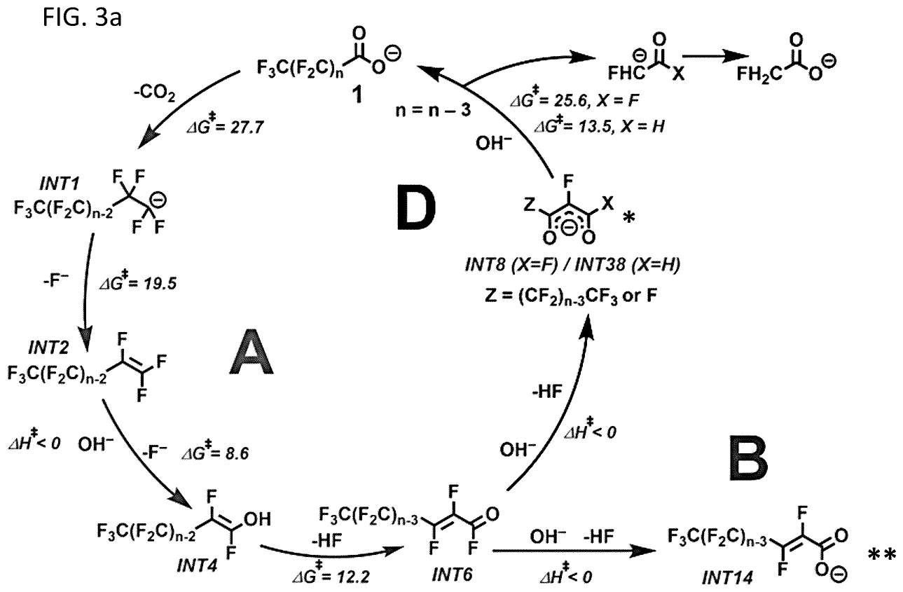

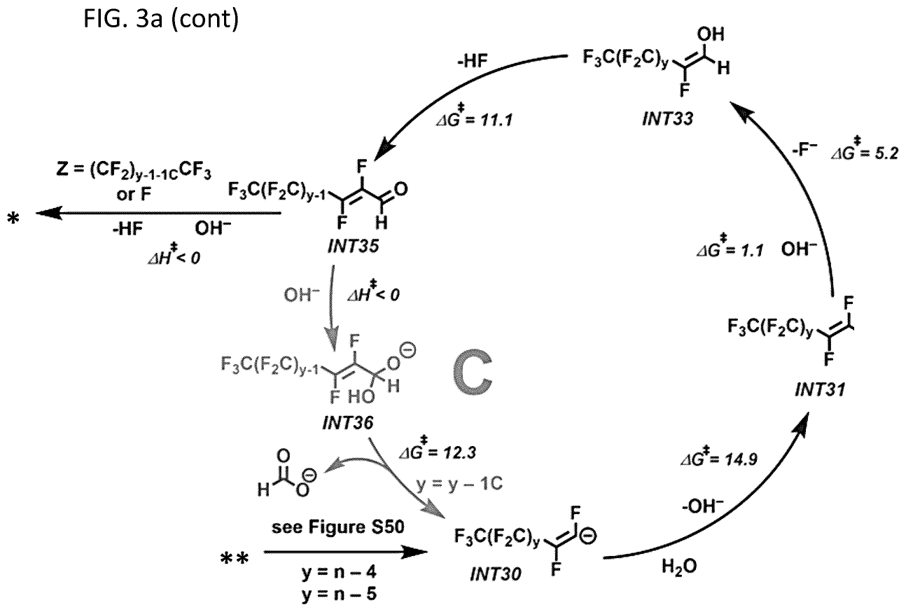

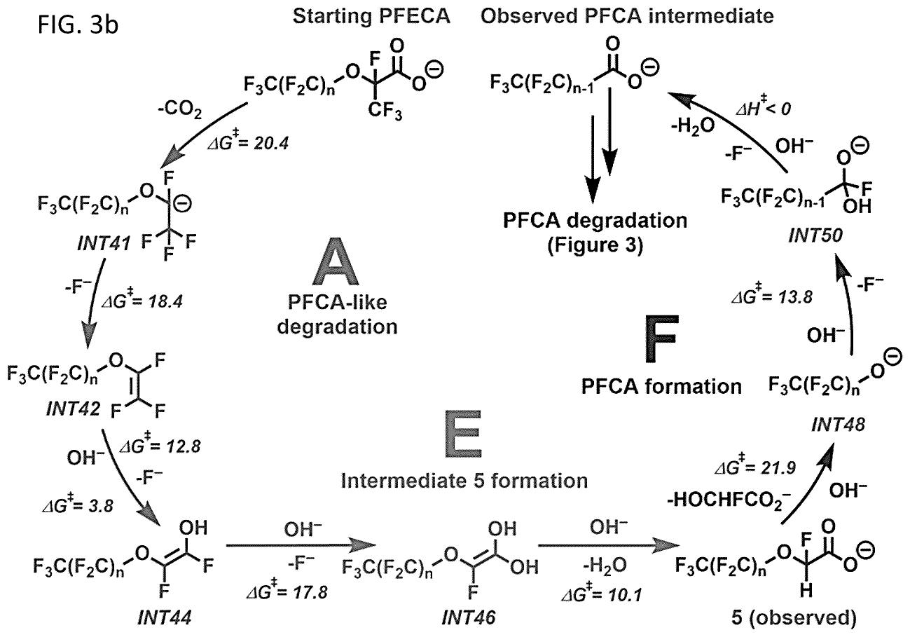

Density functional theory (DFT) was employed to determine the mechanism of this degradation reaction. These studies predict that decarboxylation is the rate-limiting step of the degradation, and that a series of low-barrier or enthalpically barrierless reactions can lead to levels of defluorination in line with experimental observations. DFT calculations were performed at the M06-2X/6-311+G (2d,p)-SMD(DMSO) level and used PFOA as the starting point for the calculations. This mechanism should also be valid for the degradation of straight-chain PFCAs of other lengths. After the initial decarboxylation of PFOA (Compound 1, FIG. 3) at an activation energy of 27.7 kcal/mol, calculations indicate the resulting anion INT1 would eliminate a fluoride to become a perfluoroalkene INT2 (FIG. 3). Unlike previous PFCA degradation mechanisms in the literature that predict the perfluoroalkyl fragment will hydroxylate after decarboxylation, these computational results point to the formation of an alkene followed by an enthalpically barrierless hydroxylation of the activated electrophilic alkene. Hydroxylation of the anionic alkyl fragment INT1, as postulated in past literature, is calculated to have an activation energy of 29.7 kcal/mol under our study's conditions, while formation of the alkene INT2 has a barrier of 19.5 kcal/mol, followed by a hydroxylation with no enthalpic barrier (ΔG=−44.3 kcal/mol). The highly exothermic nature of this alkene hydroxylation step plays a leading role in driving the degradation, in line with observations that the defluorination and chain-shortening steps of the reaction neither have high energy barriers nor lead to the formation of successively shorter PFCAs. Accordingly, when perfluoro-1-heptene 3 is subjected to the degradation conditions (Table 3), it also degrades to similar products, even at 40° C., corroborating the computational prediction and indicating that the alkene is likely on the degradation pathway. Further, calculations also suggest that the hydroxylation is specifically favored at the terminal position, as addition on the internal side of the alkene has a barrier of 8.9 kcal/mol. After this alkene hydroxylation (INT4), calculations suggest that a series of low/no-barrier reactions occur as shown in FIG. 3. The enol eliminates another fluoride, forming α,β-unsaturated acyl fluoride INT6 through retro 1,4-conjugate addition.

This resulting α,β-unsaturated acid fluoride INT6 has two plausible reaction pathways that are consistent with the experimental findings: a 1,4-conjugate addition that leads to CF₃CO₂⁻ formation (pathway D) or a 1,2 addition (pathway B) that can lead to formate formation (pathway C), which together explain the experimentally observed byproduct distribution. Calculations indicate these two options both have no enthalpic barriers and thus very low free energies of activation, indicating that both reactions occur to some extent (data not shown). In the enthalpically barrierless 1,4-conjugate addition (FIG. 3, pathway D, X=F) that leads to the formation of shorter PFCAs such as CF₃CO₂⁻, the hydroxide adds to the β carbon of α,β-unsaturated acyl fluoride INT6, followed by an enthalpically barrierless fluoride elimination to form 1,3-diketone compound INT8. Hydroxide again adds to this intermediate on the ketone carbonyl side to generate INT9, which is more favorable than the addition on the acyl fluoride side (data not shown). Finally, fragmentation occurs to generate an equivalent of perfluorocarboxylic acid three carbons shorter than the initial carboxylic acid and an equivalent of fluoroacetic acid, which was observed in the experiments conducted at 40° C. (FIG. 9, 11). As an example, if five-carbon PFCA perfluoropentanoic acid (PFPeA) went through this cycle, it would produce an equivalent of carbon dioxide (1 carbon), an equivalent of trifluoroacetic acid (2 carbons), and an equivalent of fluoroacetic acid (2 carbons) by this pathway. However, from the experimental results, only about 0.3 equiv of CF₃CO₂⁻ are produced from PFPeA (FIG. 2D), indicating the PFCA degradation does not proceed quantitatively by this process. This pathway also does not account for the substantial amounts of formate produced in reactions from longer PFCAs.

Formate ion production is explained via a pathway stemming from the favorable 1,2-hydroxylation product, which provides an α,β unsaturated perfluorocarboxylic acid (pathway B). As with INT6, there are multiple possible sites for hydroxide addition to INT14, either to the α (13.6 kcal/mol) or β (12.0 kcal/mol) carbons. Possible pathways propagating from both of these processes, along with the formation of oxalate and other carbon byproducts (FIG. 3). While both of these pathways for the conversion of INT14 to INT30 are plausible and supported by computation, the possibility of other active mechanisms cannot be ruled out. However, both of these hydroxylations are more favorable than decarboxylating the α,β unsaturated perfluoroacid (22.3 kcal/mol) and both lead to the formation of perfluoroalkene anion INT30. The chain length of the alkene depends on which hydroxylation pathway the substrate follows, either four carbons shorter than the original chain (1,3-addition) or five carbons shorter than the original chain (1,4-addition). Calculations show that perfluoroalkene anion INT30 is protonated rather than eliminating a fluoride to generate the alkyne (data not shown). After the protonation, hydroxide adds to the alkene, much like the first post-decarboxylation step in the first proposed pathway. Likewise, α,β-unsaturated aldehyde INT35, an analogue to the α,β-unsaturated acid fluoride INT6, is generated through retro-1,4-addition. At this point, the intermediate again faces a bifurcation, with opportunities for both the 1,4-conjugate addition and the 1,2-addition of the hydroxide to the α,β-unsaturated aldehyde. Similar to the addition to the α,β-unsaturated acyl fluoride, both of these reactions are calculated to have no enthalpic barrier (data not shown). Through the 1,4-conjugate addition (FIG. 3, pathway D, X=H), the 1,3-diketone compound generated will be attacked by hydroxide, followed by the same fragmentation as noted before. That is, a perfluorocarboxylic acid and a fluoroacetic aldehyde are formed, the latter of which can be transformed into fluoroacetic acid or be rapidly hydrolyzed. However, if INT35 undergoes 1,2-addition of hydroxide to the α,β-unsaturated aldehyde (FIG. 3, pathway C), the resulting aldehyde (INT36) cannot eliminate a hydride, whereas its acid fluoride counterpart INT10 can eliminate a fluoride. Instead, INT36 can eliminate the entire perfluoroalkyl chain, creating an equivalent of formate and a one-carbon-shorter alkene anion that can either exit the cycle via 1,4-conjugate addition or proceed through the cycle again to form more formate, thus giving rise to the trend of increased formate formation by PFCAs of longer chain length.

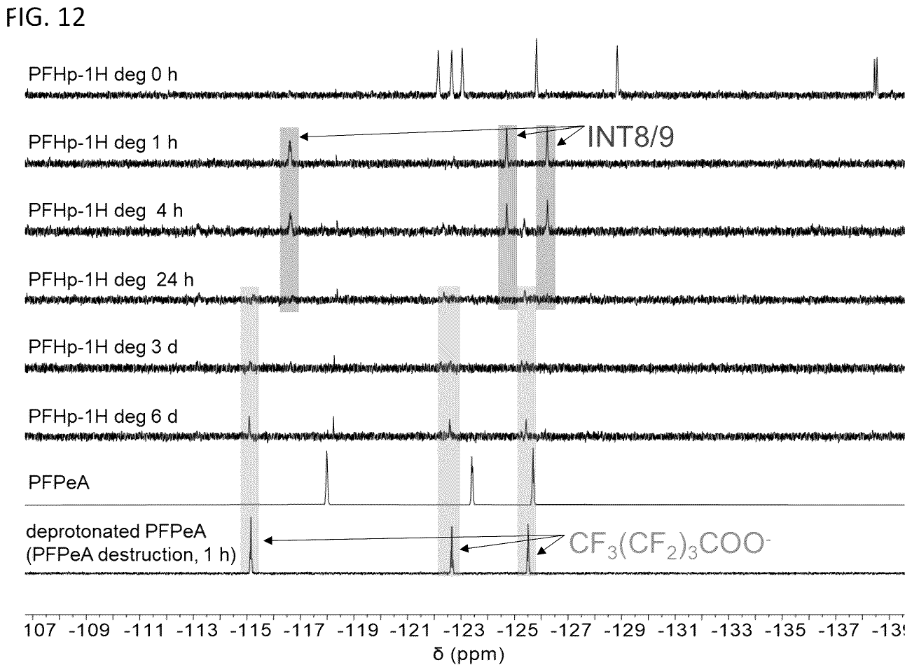

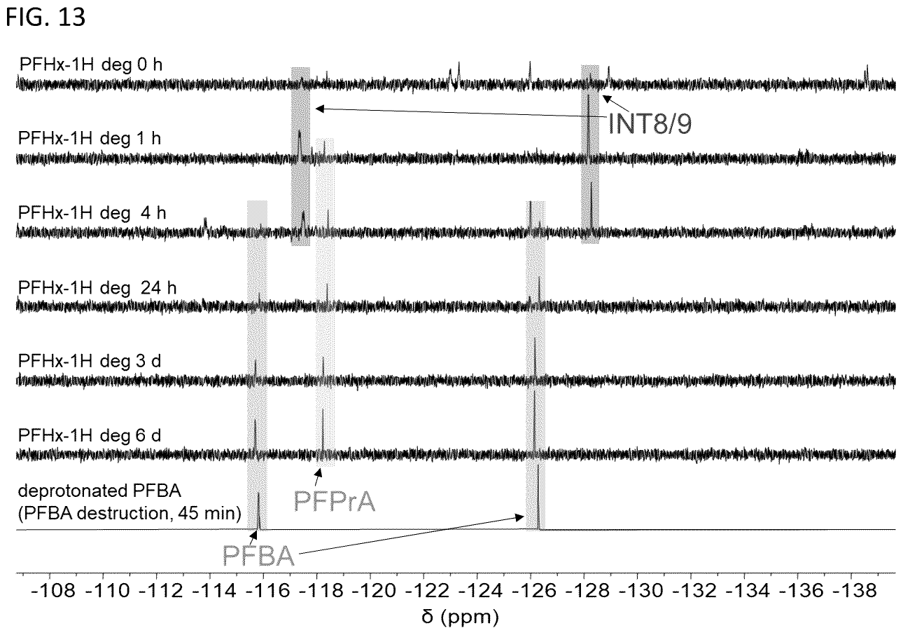

The mechanisms proposed above are consistent with several experimental observations. The calculations affirm that decarboxylation is the rate-determining step of the degradation, and the calculated activation energy of 27.7 kcal/mol is consistent with the experimentally determined value of 30.0 kcal/mol. This proposed mechanism is also supported by experimental observations of CF₃CO₂⁻ and formate distribution from FIG. 2D. By this mechanism, CF₃CO₂⁻ is produced as a non-stoichiometric byproduct, in accordance with the observation that only approximately 0.3-0.4 equivalents of CF₃CO₂⁻ are formed per mol of PFCA for all PFCA with C≥5. This proposed mechanism also explains why four-carbon PFBA does not produce CF₃CO₂⁻ while the five-carbon PFPeA does, as PFBA that has gone through cycle AD would create FCOO⁻ that will decompose spontaneously to hydrogen carbonate and fluoride (32) or would hydrolyze from INT8 to form tartronate. This two-cycle mechanism also explains why five-carbon PFPeA produces CF₃CO₂⁻ but no formate, as the carbon chain is not long enough to go through pathway C. The mechanism predicts the amount of formate will increase as the length of the initial PFCA carbon chain increases; this has also been affirmed by experimental results for PFCAs of 6-9 carbons (FIG. 2D). The formation of carbonaceous byproducts such as oxalate, glycolate, and tartronate are also consistent with this mechanism (FIG. 3). Furthermore, when conducting reactions with protodecarboxylated perfluoro-1H-heptane 2 or perfluoro-1H-hexane S1 (data not shown) at 40° C., the formation of intermediate products containing five- or four-carbon fluorous chains is observed (FIG. 12, 13), respectively, which likely correspond to INT8/INT9, the intermediate with the highest activation energy (25.6 kcal/mol) in this pathway. The peaks corresponding to this intermediate disappear as peaks corresponding to the five- and four-carbon PFCAs appear. These PFCAs that are shortened by three carbons are logical products of a single pathway AD cycle from their respective starting materials. The experimental observations confirm that the computed mechanism provides a complete model to describe the observations made experimentally about this complex degradation. We also performed calculations to test proposed difluorocarbene, perfluoroalkyl hydroxylation, and a-lactone mechanisms that had been proposed for such degradations, but these were found to have barriers too high to be compatible with the experimental conditions.

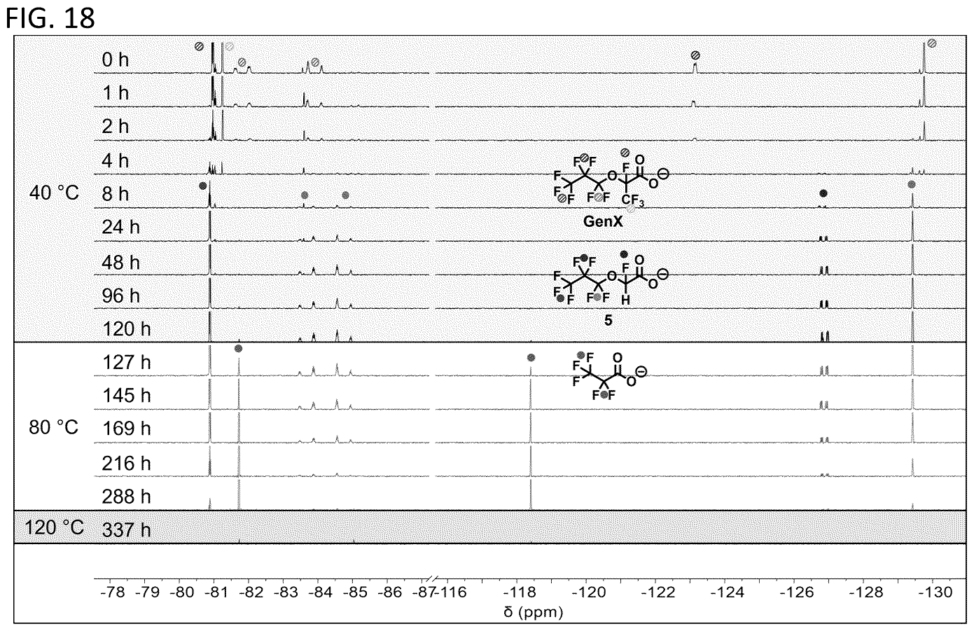

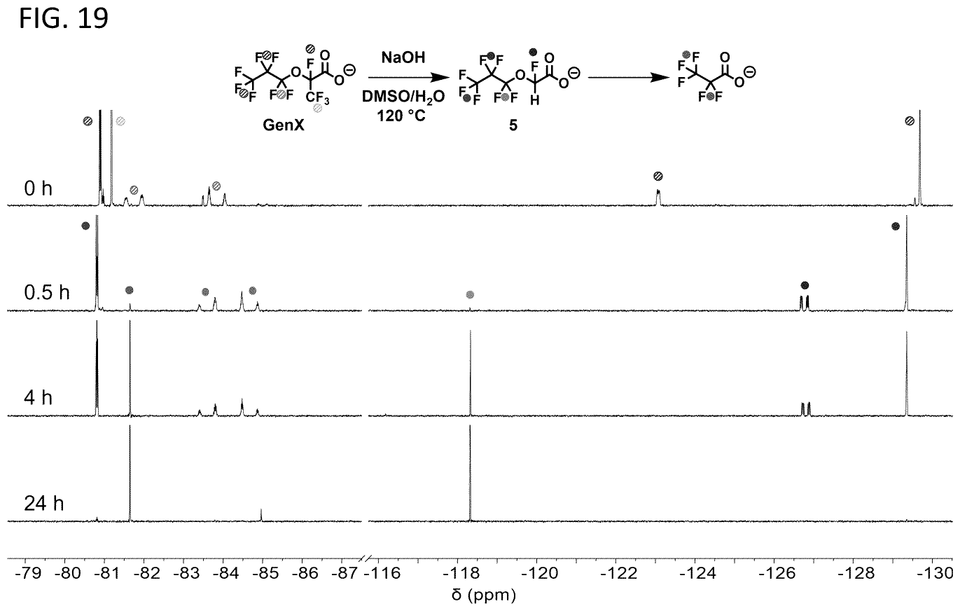

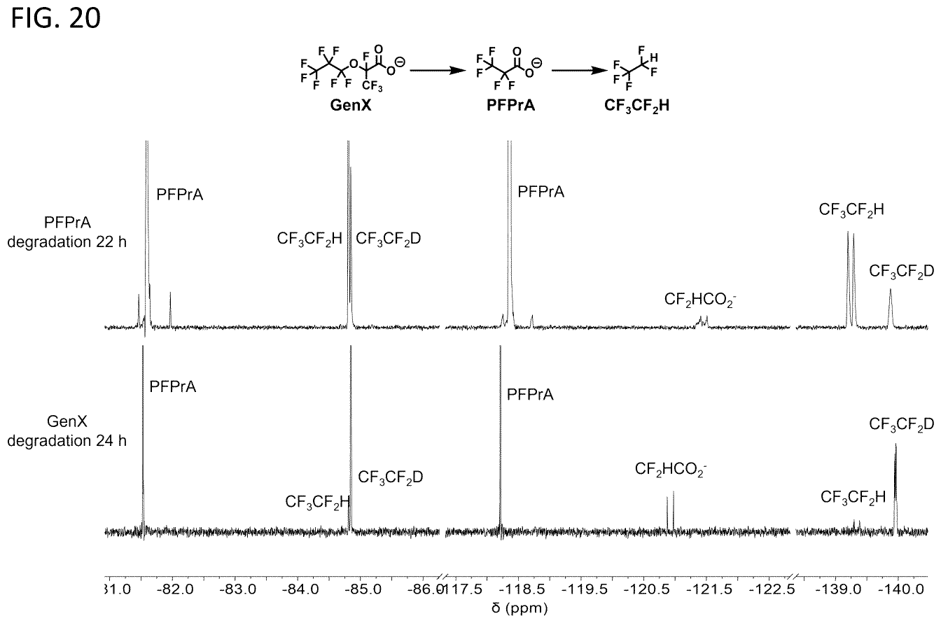

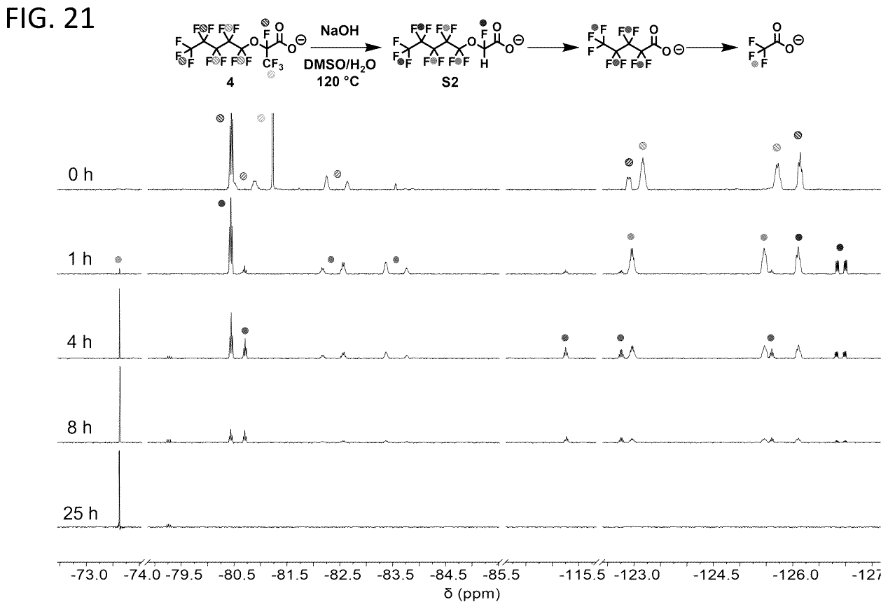

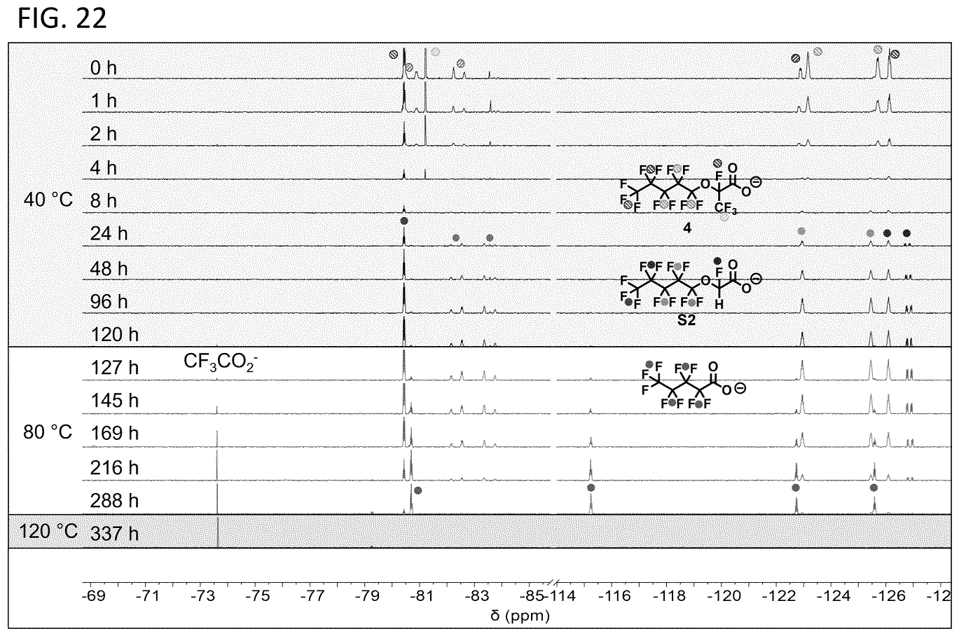

Branched perfluoroalkyl ether carboxylic acids, another major class of PFAS contaminants, are also mineralized via perfluoroalkyl anion intermediates. Ammonium hexafluoropropylene dimer acid (also known as FRD-902, the trade name GenX, or HFPO-DA in its acid form) is a perfluoroether carboxylic acid that was introduced as an industrial replacement for PFOA. The decarboxylation and branched CF₃ chain defluorination occurs at 40° C., an even lower temperature than for the PFCAs (FIG. 18). This finding is consistent with computational results indicating the barrier for GenX decarboxylation is only 20.4 kcal/mol. However, because of the presence of the ether oxygen in place of the γ-carbon, the structure is unable to eliminate a γ-fluorine and instead forms perfluoroether carboxylic acid intermediate 5 through hydrolysis (FIG. 4), which builds up in solution and was observed by both ¹⁹F NMR and ESI-MS (FIGS. 18-19). Further degradation occurs at elevated temperatures (80° C., FIG. 18). Calculations show that the decarboxylation of this intermediate is unfavorable; rather, a hydroxide-mediated S_{N}2 with a barrier of 21.9 kcal/mol occurs in which the perfluoroalkoxide tail is eliminated. This perfluoroalkoxide forms a carboxylic acid (ΔG^{‡}=21.9 kcal/mol) with the same number of carbons as the original perfluoroether tail. Because GenX contains a three-carbon tail, it produces the C3 PFCA (PFPrA), the degradation of which leads to incomplete defluorination (41%, FIG. 2D) and formation of CF₃CF₂H (FIGS. 16, 20). These observations are consistent with those of the direct degradation of PFPrA (FIG. 2D). The experimental observations show that temperatures of 40° C., 80° C., and 120° C. form INT1, to form the PFCA analogue, and to initiate PFCA degradation, respectively. These temperature steps correspond with the calculated energy barriers of 20.4 kcal/mol, 21.9 kcal/mol, and 27.7 kcal/mol, respectively (FIG. 18). Degradation of a longer perfluoroalkyl ether acid with a five-carbon perfluoroalkyl tail (Compound 4, FIGS. 16, 21-22) proceeded by a similar mechanism as that of GenX, and gave fluoride recoveries consistent with those obtained from the five-carbon PFCA, PFPeA. These findings indicate that perfluoroalkyl ether carboxylates also degrade via perfluoroalkyl anion-based processes. Intermediates in the degradation of 4, as observed by APCI-MS (data not shown), corroborate the proposed mechanism (FIG. 4).

This newly discovered perfluorocarbon reactivity leverages low-barrier defluorination mechanisms to mineralize PFAS at mild temperatures with high rates of defluorination and low organofluorine side product formation. In contrast to other proposed PFAS degradation strategies, the conditions described here are specific to fluorocarbons, destroy concentrated PFCAs, give high fluoride ion recovery and low fluorinated byproduct formation, and operate under relatively mild conditions with inexpensive reagents. The proposed mechanism is consistent with both computational and experimental results, provides significant insight into the complexity of PFAS mineralization processes, and may be operative but unrecognized in other PFAS degradation approaches. The newly recognized reactivity of perfluoroalkyl anions, and the ability to access such intermediates efficiently from PFCAs, shows great promise for addressing the global PFAS contamination problem.

### Miscellaneous

Unless otherwise specified or indicated by context, the terms “a”, “an”, and “the” mean “one or more.” For example, “a molecule” should be interpreted to mean “one or more molecules.” As used herein, “about”, “approximately,” “substantially,” and “significantly” will be understood by persons of ordinary skill in the art and will vary to some extent on the context in which they are used. If there are uses of the term which are not clear to persons of ordinary skill in the art given the context in which it is used, “about” and “approximately” will mean plus or minus ≤10% of the particular term and “substantially” and “significantly” will mean plus or minus >10% of the particular term.

As used herein, the terms “include” and “including” have the same meaning as the terms “comprise” and “comprising.” The terms “comprise” and “comprising” should be interpreted as being “open” transitional terms that permit the inclusion of additional components further to those components recited in the claims. The terms “consist” and “consisting of” should be interpreted as being “closed” transitional terms that do not permit the inclusion additional components other than the components recited in the claims. The term “consisting essentially of” should be interpreted to be partially closed and allowing the inclusion only of additional components that do not fundamentally alter the nature of the claimed subject matter.

All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

All references, including publications, patent applications, and patents, cited herein are hereby incorporated by reference to the same extent as if each reference were individually and specifically indicated to be incorporated by reference and were set forth in its entirety herein.

Preferred aspects of this invention are described herein, including the best mode known to the inventors for carrying out the invention. Variations of those preferred aspects may become apparent to those of ordinary skill in the art upon reading the foregoing description. The inventors expect a person having ordinary skill in the art to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

### Examples

### Materials, Instrumentation, and Computational Methods

### Materials

Reagents were purchased in reagent grade from commercial suppliers and used without further purification, unless otherwise described. Anhydrous DMSO was obtained by drying with activated 4 Å molecular sieves. Reagents were purchased from Fisher or Sigma unless specified.

4,4′-difluorobenzophenone NMR standard (Merck) was prepared by diluting to 0.095 M in DMSO-d₆ and adding 60-80 μL of solution to a coaxial NMR tube insert (Wilmad-Lab Glass, WGS-5BL). Each ¹⁹F NMR sample was referenced to 4,4′-difluorobenzophenone (−106.5 ppm) by inserting the coaxial tubes containing the external NMR standard into the NMR sample tube before NMR analysis. ¹³C NMR samples were quantified using a sodium acetate standard in D₂O (50 μL, 5.33 M). ¹H NMR samples were quantified using 4,4′-dihydroxybiphenyl dissolved in DMSO-d₆ (0.68 M). Quantification of samples was conducted by integrating each NMR peak and normalizing with the external standard peak integration, then converting to molar concentration using the known molar amount of the external standard. 25 mL PTFE round bottom flasks were purchased from Ace Glass (United States, 13438-16).

PFCA degradation reactions were conducted on 0.5 mmol or 1 mmol scales.

### Instruments

Proton nuclear magnetic resonance (¹H NMR) spectra and fluorine nuclear magnetic resonance (¹⁹F NMR) spectra were recorded at 25° C. on a 400 MHz Bruker Avance III HD Nanobay equipped with a BBFO Smart probe w/Z-Gradient (unless stated otherwise). Fluorine-decoupled carbon nuclear magnetic resonance (¹³C NMR) spectra and two-dimensional C—F spectra were recorded on a Bruker Neo 600 MHz system with a QCI-F cryoprobe w/Z-Gradient. Quantitative ¹³C NMR spectra were recorded on a Bruker Avance III 500 MHz system equipped with a 5 mm DCH CryoProbe w/Z-Gradient using a 40 second D1 delay. Other spectra were recorded on a Bruker Avance III 600 MHz with a BBFO Smart Probe w/Z-Gradient. Experiments used pulse programs adapted from standard Bruker pulses library.

Ion chromatography was performed using a Thermo Scientific Dionex ICS-5000+ equipped with a Dionex AS-DV autosampler and using a Dionex IonPac AS22 column (Product No. 064141, Thermo Scientific, California, USA). The analysis was run using an eluent of 4.5 mM sodium carbonate and 1.4 mM sodium bicarbonate (Product No. 063965 from Thermo Scientific, California, USA) and a Dionex AERS 500 Carbonate 4 mm Electrolytically Regenerated Suppressor (Product No 085029 from Thermo Scientific, California, USA). A flow rate of 1.2 mL/min was used, giving the following retention times: fluoride=3.3 min; formate=3.8 min. Elemental standards containing 1000 μg/mL F, and 1000 μg/mL HCOO⁻ (ICF1, ICHCO1, respectively, from Inorganic Ventures, Christiansburg, VA, USA) were mixed to make quantitative standards consisting of 50, 25, 12.5, 6.25, 3.125, 1.56, 0.78 ug/mL of each anion in ultra-pure H₂O (18.2 M (2·cm). Ultra pure H₂O was used as the calibration blank. Validation experiments indicated an error of approximately 10% for ion chromatography results.

APCI-MS was collected on an Agilent 6545 QTOF Mass Spectrometer equipped with Atmospheric Pressure Chemical Ionization (APCI) source coupled with Agilent 1200 series LC running in direct injection mode. Data acquisition and analysis were done on Agilent Mass Hunter software.

GC/MS analysis was performed in the Reactor Engineering and Catalyst Testing (REACT) core facility at Northwestern University using an Agilent 6850 GC system coupled to an Agilent 5975C MS system. Helium (Airgas, 99.999%) was purified using an Agilent “Big Universal Trap” (Model RMSH-2) and used as a carrier gas. Gas separation was performed using a HP-Plot Q column (19091P-Q04E, 30 m×0.320 mm×20 um) starting at 50° C. for 4 minutes. The temperature was then ramped to 220° C. at 30° C./min and held for 3 minutes. The flow rate of He was maintained at 1.2 mL/min (inlet split ratio of 10:1). The MS was operated in scan mode (Gain factor=1, EM voltage =2518, MS Source=250° C., MS Quad=150° C.) from m/z=5 to m/z=300. A solvent delay was not used.

Kinetic traces for PFOA degradation at different temperatures were fitted to the equation y=ae^{-x/b}+c in MATLAB using the Curve Fitting application.

Geometry optimizations, frequency analyses, and single-point energies were calculated at the theoretical M06-2X/6-311+G (2d,p)-SMD-(DMSO) level (36, 37) using the Gaussian 16 package (38) with default convergence criteria. M06-2X functional gives refined energies for organic systems (39). Frequency outcomes were examined to confirm stationary points as minima (no imaginary frequencies) or transition states (only one imaginary frequency). Paton's GoodVibes (40) was used to correct entropy and enthalpy by Grimme's quasi-harmonic approximation (41) and Head-Gordon's method (42). 3D structures of molecules were generated by CYL view (43). All energies are in kcal/mol if not labeled otherwise. All bond lengths are in Angstroms (Å).

### Synthetic Procedures and NMR Characterization of Synthesized Compounds

General PFCA Destruction Procedure: Perfluorooctanoic acid (207 mg, 0.500 mmol) and sodium hydroxide (0.600 g, 15.0 mmol) were added to a 25 mL PTFE round bottom flask along with a PTFE-coated magnetic stirbar. 5 mL DMSO was added to the reaction vessel, followed by 0.625 ml distilled or de-ionized water. The vessel was sonicated for approximately 15 seconds, then the t=0 aliquot was taken by diluting a 50 μL aliquot into 500 μL of deuterated solvent. The vessels were sealed with a rubber septum and pierced with a needle that was left in the septum to prevent overpressure. The vented vessels were then added to an oil bath preheated to 120° C. and stirred at 500 RPM for the specified time, usually 24 hours. Liquid aliquots for reactions monitored over time were taken using a syringe inserted through the rubber septum and diluted as above with solids removed by centrifugation if necessary. The reactions were removed from the heat and cooled for at least 40 minutes before workup. The entire contents of the reaction were diluted with distilled or deionized water until the solids at the bottom were completely dissolved (typically 20-40 mL water added) and were transferred to a polypropylene centrifuge tube. The resulting fluoride- and formate-containing solution was further diluted in water 100×-500× for ion chromatography analysis. For carbonaceous products quantification, the contents of the reaction were added to a 15 mL polypropylene centrifuge tube, centrifuged, and the DMSO solvent was decanted. The remaining solids were rinsed and centrifuged 2× with dichloromethane, then dried overnight at 120° C. on high vac. A portion of the solids (˜30 mg) was dissolved (750 μL D₂O+50 μL NaOAc standard in D₂O) for quantitative ¹³C NMR analysis.

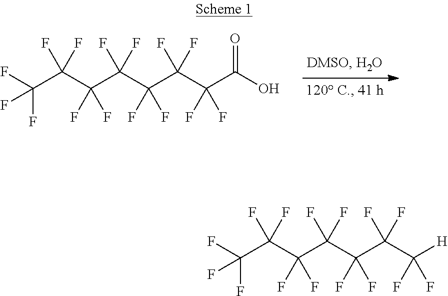 [SMILES: O=C(O)C(F)(F)C(F)(F)C(F)(F)C(F)(F)C(F)(F)C(F)(F)C(F)(F)F ; FC(F)C(F)(F)C(F)(F)C(F)(F)C(F)(F)C(F)(F)C(F)(F)F]

General procedure to decarboxylate perfluorocarboxylic acids and synthesis of perfluoro-¹H-heptane (2). PFOA (1.035 g, 2.500 mmol) was added to a glass pressure vessel with PTFE screw-top and PTFE-coated magnetic stirbar and dissolved in a mixture of DMSO (5.00 mL) and deionized H₂O (0.625 mL). The solution was heated to 120° C. for 41 h, then was removed from heat and allowed to cool to room temperature for 2 h. The product phase-separated as a clear liquid on the bottom of the vessel and was decanted via micropipette to provide 2 as a colorless oil (0.703 g, 76% yield). ¹⁹F NMR (564 MHz, DMSO) δ−83.614, −123.990, −124.648, −125.218, −128.289, −131.643, −140.332. ¹³C NMR (151 MHz, DMSO) δ 116.223, 109.800, 109.315, 109.196, 109.152 (d, J²_{CH}=7.5 Hz), 107.548, 107.498, 106.194 (d, J¹_{CH}=197.7 Hz). ¹H NMR (400 MHZ, DMSO) δ 5.94 (tt, J=51.4, 5.1 Hz, 1H).

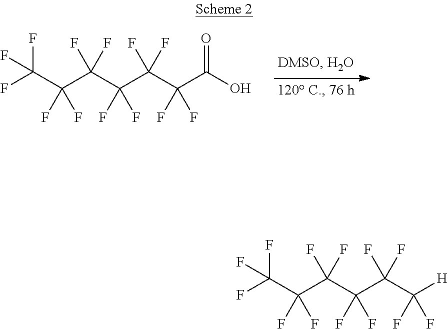 [SMILES: O=C(O)C(F)(F)C(F)(F)C(F)(F)C(F)(F)C(F)(F)C(F)(F)F ; FC(F)C(F)(F)C(F)(F)C(F)(F)C(F)(F)C(F)(F)F]

Perfluoro-1H-hexane (S1). S1 was obtained using the above procedure as a colorless oil (0.654 g, 84% yield). ¹⁹F NMR (564 MHz, DMSO) δ−83.73 (tt, J=10.4, 2.4 Hz), −124.955, −125.559, −128.487, −131.875, −140.31 (d, J=51.7 Hz). ¹³C NMR (151 MHz, DMSO) δ 116.282, 109.757, 109.340, 109.13 (d, J=6.6 Hz), 107.560, 106.81 (d, J=195.8 Hz). ¹H NMR (600 MHZ, DMSO) δ 5.85 (tt, J=51.7, 5.1 Hz, 1H).

### Experimental Determination of ΔG^{‡}

ΔG^{‡} was determined using the Eyring equation:

$$k = \frac{κ {k}_{B} T}{h} {e}^{- \frac{Δ {G}^{‡}}{R T}}$$

where
κ is the transmission coefficient, assumed to be 1 in this case,
k_{B} is the Boltzmann constant (1.38×10⁻²³ J/K),
T is the temperature in Kelvin,
h is Planck's constant (6.626×10⁻³⁴ J·s),
ΔG^{‡}is the Gibbs energy of activation,
R is the gas constant (8.3145 J/mol·K, or 1.987 cal/mol·K), and
ΔG^{‡}₃₉₃=30.0 kcal/mol.

### Quantification of Carbon-Containing Byproducts

Quantitative ¹³C NMR spectroscopy of the precipitate accounted for almost all of the carbon-containing species generated by the PFOA degradation reaction, none of which contain C—F bonds besides trifluoroacetate ions (Table 4). The byproducts were identified as a distribution of one-carbon (carbonate, formate), two-carbon (oxalate, glycolate, trifluoroacetate), and three-carbon products (tartronate). Quantification by ¹³C NMR spectroscopy of the precipitate and ¹H NMR spectroscopy of the reaction solution indicated 2.5±0.3 equivalents of formate per mol of PFOA starting material (Table 4). The formate ions were independently quantified by ion chromatography and corresponded to 2.1±0.2 equivalents of formate per mol of PFOA starting material (FIG. 2D). There are several potential pathways for the generation of some of these carbon-containing products that are not further explored in this work. However, the formation of non-fluorinated, relatively oxidized 1-3 carbon products is generally consistent with the proposed mechanism, while accounting for all of the carbon balance of the PFOA degradation reaction.

One Carbon Products: Under the basic reaction conditions, the carbon dioxide reacts with excess hydroxide ions to provide sodium carbonate within the precipitate. 2.1±0.3 equivalents of carbonate ions per mol of PFOA were detected by quantitative ¹³C NMR spectroscopy. 2.5±0.3 equivalents of formate per mol PFOA were detected, as measured by ¹H NMR spectroscopy of the liquid reaction mixture and ¹³C NMR spectroscopy of the precipitate. It should be noted that the carbonate ion concentration could not be independently measured by ion chromatography because available IC capabilities were run in carbonate-based buffers, precluding the detection of this ion.

Two Carbon Products: 0.32±0.04 mols of trifluoroacetate per mol of PFOA were detected by ¹⁹F NMR spectroscopy of the reaction solution at 24 h reaction time; only trace CF₃CO₂ was found in the precipitate by ¹⁹F NMR spectroscopy. 0.6±0.1 mols of glycolate ions per mol of PFOA were detected, some of which might be formed from the degradation of fluoroacetic acid, which was observed in low-temperature experiments (see main text). Oxalate ions were detected at concentrations corresponding to 0.7±0.1 mols per mol of PFOA.

Three Carbon Products: We assign another carbon-containing product as sodium tartronate (0.2±0.1 equiv per mol PFOA) based on its ¹³C NMR resonance at 177 ppm, which correlates with a ¹H NMR resonance at 4.2 ppm (data not show). These chemical shifts match literature reports (29, 44), and the correlation is consistent with an intermediate we propose in the mechanism (FIG. 3). We propose that tartronate is formed in pathway D because it was observed in greater amounts in the degradation of PFBA (C=4), likely from hydrolysis of INT8 (FIG. 3).

Unidentified Product: An unidentified product (4.9±2.4 mol % C) is likely derived from the reaction of glycolic acid with another intermediate in the pathway, as it was formed in higher concentration when glycolic acid and PFOA were subjected to the degradation conditions together. However, the unknown product did not form when glycolic acid was subjected to the degradation conditions in the absence of PFOA. The unidentified compound has two ¹³C NMR resonances, one at 177.9 ppm and one at 69.4 ppm (FIG. 17). The two resonances integrate 1:1 with each other, making it likely that it contains either two or four carbons.

Further analysis of the reaction precipitates from degrading the C=2, 4, 5, and 6 acids (FIG. 17) showed that the presence of oxalate was correlated with the presence of TFA, but it is not a direct degradation product of TFA, whose only carbon-containing degradation products were carbonate ions. The amount of oxalate appeared to increase slightly for PFCA with longer perfluoroalkyl chains, such that we speculate that it is formed, at least in part, within the B/C pathways, as are formate ions. Once the fluorocarbon intermediate is protonated, though, as in INT31 (FIG. 3), it is difficult to get the correct oxidation state for oxalate except through Cannizzaro reactivity or disproportionation, which could be possible under the extremely basic reaction conditions. We think it is likely that the oxalate either originates from a process in the B pathway preceding INT31 or from further degradation of carbonaceous byproducts.

### Computational Mechanistic Investigations

Decarboxylation is the rate-determining step of thermolysis with an energy barrier of 27.7 kcal/mol. This is also consistent with the experimental conditions that decarboxylation requires 120° C. to initiate. Relaxed-scan comparisons of the decarboxylation energy profiles in both gas and liquid phase show that the solvent effect plays a significant role. The energy profile in the liquid phase has a maximum value, while the energy profile in the gas phase keeps rising, indicating that in the gas phase, the products formed by decarboxylation will return to the reactant with a very low energy barrier. Hydroxide in the solvent may play a significant role in promoting decarboxylation.

Perfluoroanion INT1 can eliminate a fluoride to become a perfluoroalkene INT2 or be protonated by water to become a polyfluoroalkane. Since S_{N}2 reactions on saturated fluoroalkane carbons require a high energy barrier, INT1 is more likely to generate perfluoroalkene INT2.

The resulting alkene INT2 is easily hydroxylated; our calculations also suggest that the hydroxylation is specifically favored at the terminal position. The relaxed-scan addition energy profiles on the internal side and the terminal side show that the addition on the internal side of the alkene has a barrier of 8.9 kcal/mol, whereas addition on the terminal side does not have an enthalpic barrier.

After the formation of hydroxylated perfluoroanion INT3, two consecutive fluoride ion eliminations produce α,β-unsaturated acyl fluoride INT6. The carbon-oxygen bond length scanning coordinates of INT7 and INT13 do not have inflection points but continuously rise, showing that neither 1,2-addition nor 1,4-addition have enthalpic barriers.

1,4-addition produces 1,3-diketone compound INT8. Subsequent hydroxide addition is favored to occur on the ketone carboxyl side of INT8 rather than the acyl fluoride side.

While 1,4-addition leads to the formation of shorter PFCAs such as CF₃CO₂⁻, 1,2-addition can lead to the eventual formation of byproduct HCOOH. The 1,2-hydroxylation produces α,β unsaturated perfluorocarboxylic acid INT14, then generates an alkene anion INT30. Several pathways for generating INT30 from INT14 exist.

We propose two possible pathways for the transformation of INT14 to INT30. In Pathway B″, hydroxide addition to the alpha carbon allows an acid fluoride equivalent of oxalate to be generated, eliminating a fluoroalkene anion five carbons in length (for PFOA; generalized to other PFCAs, the alkene is three carbons shorter than the original PFCA length) with a barrier of 24.8 kcal/mol. In Pathway B′, 1,4 addition of the hydroxide to INT14 leads to a Darzens-type decarboxylation through an epoxide intermediate INT19 via TS11 with a barrier of 19.4 kcal/mol. Interestingly, though carbonate INT18 has a similar structure to acid fluoride INT9, they have different reactivity. INT9 tends to fragment, while INT18 tends to form the epoxide because it cannot form a dianion through fragmentation. For longer PFCAs (original PFCA C >6), the unsaturated aldehyde intermediate can eliminate a fluoride and pass through a Pathway C-like process (Pathway C′) where hydroxide adds to the carbonyl and eliminates off an alkene four carbons shorter than the original PFCA (for PFOA, four carbons in length) and an equivalent of glyoxylate, which can disproportionate into an equivalent of oxalate and an equivalent of glycolate (45).

The mechanisms explicitly proposed in FIG. 3 and its supporting figures show many classes of reactivity at the possible bifurcation points. For example, the C and C′ reactivity modes are the same, even though the resulting byproducts are different; similarly, pathway D-type retro-aldol reactions could occur at other 1,3-dicarbonyl intermediates to create a PFCA+carboxylic acid byproduct equivalent. We expect that the reactivity motifs we have explored through computation may be active at intermediates in the mechanism other than what we have explicitly shown.

Calculation results show that protonating the alkene anion INT30 is more favorable than eliminating a fluoride to generate the alkyne, the hydroxide addition is more likely to happen on the terminal side of INT31 as it was for the fully fluorinated INT2, and solvent effects can reduce the energy barrier for protonation. Likewise, two consecutive eliminations of fluoride ions generates α,β-unsaturated aldehyde INT35, an analogue to the α,β-unsaturated acid fluoride INT6. The scanning coordinates of carbon-oxygen bonds length of INT36 and INT37 show that neither 1,2-addition or 1,4-addition to INT35 have enthalpic barriers. The 1,2-addition leads to the production of formate through elimination, while the 1,4-addition can exit the cycle and generate shorter PFCAs through pathway D (FIG. 3). As with analogue INT8, hydroxide addition is more favorable on the ketone carboxyl side of 1,3-diketone compound INT38.

### TABLES

TABLE 2
Summary of kinetic fitting parameters for degradation
of PFOA at various temperatures.

| | | | | | adjusted | trial |
|---|---|---|---|---|---|---|
| ° C. | a | b | c | k | R² | replicates |
| 80 | 0.07476 | 2.90 × 10⁵ | 0.02057 | 3.45 × 10⁻⁶ | 0.9466 | single run |
| 90 | 0.06934 | 8.62 × 10⁴ | 0.01227 | 1.16 × 10⁻⁵ | 0.9842 | duplicate |
| 100 | 0.07908 | 3.82 × 10⁴ | 0.00953 | 2.62 × 10⁻⁵ | 0.9813 | triplicate |
| 120 | 0.08268 | 6.32 × 10³ | 0.00449 | 1.58 × 10⁻⁴ | 0.9949 | triplicate |

Kinetic fitting parameters for PFOA degradation at different temperatures as fitted to the equation y = ae^{-x/b} + c in MATLAB using the Curve Fitting application.

TABLE 3
Defluorination of various PFAS substrates
under varying conditions.

| Compound | Solvent | Temp (° C.) | Time | | F IC %^{a} |
|---|---|---|---|---|---|
| 2 | DMSO | 40 | 25 | min | 4% |
| 1 | DMSO | 40 | 25 | min | n.d. |
| 2 | DMSO | 120 | 5 | min | 11% |
| 1 | DMSO | 120 | 5 | min | n.d. |
| 2 | DMSO | 40 | 48 | h | 57% |
| 3 | DMSO | 40 | 48 | h | 70% |
| PFOS | DMSO | 120 | 150 | h | 0.3% |
| 1 | DMAc^{b} | 120 | 44 | h | 31% |
| 1 | sulfolane^{b} | 120 | 44 | h | 38% |
| 1 | water | 120 | 44 | h | 0.1% |
| control^{c} | DMSO | 120 | 24 | h | 0.2% |

Defluorination of various PFAS substrates under varying conditions, as measured by fluoride ion concentrations detected by ion chromatography. Perfluoro-1H-heptane (2) gives greater fluoride recovery than PFOA at the same times and temperatures, suggesting that decarboxylation is the rate-limiting step in this degradation. Even at low temperatures, 2 and perfluoro-1-heptene (3) both give relatively efficient defluorination (>50%). PFOS does not react under these conditions, and PFOA (1) does not defluorinate in pure water, only in polar aprotic solvents such as dimethylacetaminde (DMAc) or sulfolane. Control experiments run without PFOA show that the polytetrafluoroethylene reactor does not release fluoride into the reaction. ^{a}n.d.=not detected. ^{b}Using standard conditions for DMSO; not optimized for other solvents. 100% degradation of PFOA as all ¹⁹F NMR peaks disappeared. “Percent calculated relative to a 1 mmol PFOA degradation reaction; average of triplicate reactions.

TABLE 4
Distribution of carbonaceous byproducts of the PFOA degradation
reaction, as measured by quantitative ¹³C NMR spectroscopy of the
isolated reaction precipitate dissolved in D₂O.

| Compound | Mol % C relative to PFOA | Mol/Mol PFOA |
|---|---|---|
| Formate^{a} | 31.1 ± 4.0 | 2.5 ± 0.3 |
| Carbonate | 25.7 ± 3.1 | 2.1 ± 0.3 |
| Oxalate | 17.8 ± 3.0 | 0.7 ± 0.1 |
| Glycolate | 15.0 ± 1.4 | 0.6 ± 0.1^{c} |
| Trifluoroacetate^{b} | 8.0 ± 1.0 | 0.32 ± 0.04 |
| Tartronate^{c} | 4.3 ± 1.1 | 0.2 ± 0.1^{c} |
| Unidentified | 4.9 ± 2.4 | 0.4 ± 0.2^{c} |
| Total | 106.7 ± 8.3 | 8.5 ± 0.7^{d} |

Unless noted, all errors reported as standard deviation of triplicate measurements.
^{a}Calculated by adding the formate in the reaction solvent, as measured by ¹H NMR, to the formate in the reaction precipitate, as measured by ¹³C NMR.
^{b}Calculated via ¹⁹F NMR spectroscopy.
^{c}Error estimated as 0.1 based on the signal-to-noise of NMR resonances for low-concentration species. Errors for other products are given as the standard deviation of triplicate measurements.
^{d}Calculated as mols of carbon per mol of PFOA; i.e., accounting for compounds that have multiple carbons integrated in the analysis.

1. A method for mineralizing a perfluoroalkyl and polyfluoroalkyl substance (PFAS), the method comprising heating a solution comprising the PFAS, a base, and a polar aprotic solvent to an effective mineralization temperature.

2. The method of claim 1, wherein the effective mineralization temperature is 80-140° C.

3. The method of claim 1, wherein the polar aprotic solvent comprises dimethyl sulfoxide.

4. The method of claim 1, wherein the base comprises a metal hydroxide.

5. The method of claim 4, wherein the base comprises sodium hydroxide.

6. The method of claim 1, wherein the solution comprises water.

7. The method of claim 1, wherein the PFAS comprises a perfluoroalkyl carboxylic acid, a perfluoroalkyl ether carboxylic acid, a perfluoro-1H-alkane, a perfluoro-1H-alkene, or any combination thereof.

8. The method of claim 1, wherein the polar aprotic solvent comprises dimethyl sulfoxide and the base comprises a metal hydroxide.

9. The method of claim 8, wherein the effective mineralization temperature is 80-140° C.

10. The method of claim 8, wherein the PFAS comprises a perfluoroalkyl carboxylic acid, a perfluoroalkyl ether carboxylic acid, a perfluoro-1H-alkane, a perfluoro-1H-alkene, or any combination thereof.

11. The method of claim 1, further comprising recovering fluoride ion.

12. The method of claim 11, wherein at least 50% of the PFAS fluorine is recovered as fluoride ion.

13. A method for mineralizing a per- or a polyfluoroalkyl substance (PFAS), the method comprising heating a concentrated solution of the PFAS, a base, and a polar aprotic solvent to an effective mineralization temperature.

14. The method of claim 13, wherein the concentrated solution of the PFAS is prepared by recovering PFAS from an adsorbent.

15. The method of claim 13, wherein the concentration solution of the PFAS is prepared by contacting a PFAS contaminated liquid with an adsorbent and recovering the PFAS from the adsorbent.

16. (canceled)

17. (canceled)

18. The method of claim 14, wherein the adsorbent is an activated carbon, an ion-exchange resin, or a cross-linked polymer.

19. The method of claim 18, wherein the absorbent is a cross-linked cyclodextrin polymer.

20. The method of claim 13, wherein the effective mineralization temperature is 80-140° C.

21. (canceled)

22. (canceled)

23. (canceled)

24. (canceled)

25. The method of claim 13, wherein the PFAS comprises a perfluoroalkyl carboxylic acid, a perfluoroalkyl ether carboxylic acid, a perfluoro-1H-alkane, a perfluoro-1H-alkene, or any combination thereof.

26. The method of claim 13, further comprising recovering fluoride ion.

27. (canceled)
